(19) United States
(12) Patent Application Publication
(10) Pub. No.: US 2026/0258213 A1
(43) Pub. Date: Sep. 3, 2026

(54) FOAM COMPOSITION INCLUDING SURFACE-MODIFIED NANOPARTICLES AND RELATED ARTICLES AND PROCESSES

(71) Applicant: 3M INNOVATIVE PROPERTIES COMPANY, St. Paul, MN (US)

(72) Inventors: Jenny B. Werness, St. Paul, MN (US); David W. Stegink, Mendota Heights, MN (US); Mark D. Purgett, Oakdale, MN (US); Travis Q. Gregar, Maplewood, MN (US); Carla S. Thomas, Woodbury, MN (US); Joseph A. Orrock, Woodbury, MN (US); Youhoon Kim, Woodbury, MN (US); Peter J. Elliott, Mahtomedi, MN (US); Rachel M. Lucking, Oakdale, MN (US); Sonja S. Mackey, St. Paul, MN (US); Kerstin Unverhau, Neuss (DE); James A. Bergman, St. Paul, MN (US); Jitendra S. Rathore, Woodbury, MN (US)

(21) Appl. No.: 18/870,845

(22) PCT Filed: Jun. 2, 2023
(86) PCT No.: PCT/IB2023/055701

§ 371 Date: Dec. 2, 2024

Related U.S. Application Data
(60) Provisional application No. 63/348,393, filed on Jun. 2, 2022.

(51) Int. Cl. C08J 9/00; C08G 77/00; C08G 77/04; C08G 77/46; C08K 9/06; C08L 83/04; C08L 83/12; C09J 4/06; C09J 11/04; C09J 183/04; C09J 183/12

(52) U.S. Cl. CPC C08J 9/008; C08G 77/04; C08G 77/46; C08J 9/0061; C08L 83/04; C08L 83/12; C09J 4/06; C09J 11/04; C09J 183/04; C09J 183/12; C08G 77/70; C08G 2170/60; C08J 2383/04; C08J 2383/12; C08J 2433/10; C08K 9/06; C08K 2201/011; C08L 2203/14

(57) ABSTRACT

A foam composition includes a vehicle, surface-modified nanoparticles disposed in the vehicle, and at least one of a silicone MQ resin or a poly(alkyleneoxide)-modified polydimethylsiloxane. The individual nanoparticles having a particle diameter of less than about 100 nanometers. The vehicle can have voids therein. Articles including the foam composition and processes for making the foam composition and articles are also described.

### CROSS-REFERENCE TO RELATED APPLICATION

This application claims priority to U.S. Provisional Application No. 63/348,393, filed Jun. 2, 2022, the disclosure of which is incorporated by reference in its entirety herein.

### BACKGROUND

In a foam, gas bubbles are separated from each other by thin liquid films. Typically, surfactants function by lowering the surface tension of the liquid such that a gas bubble introduced below the surface of the liquid can be maintained in the liquid. Surfactants can also stabilize foams by adsorbing at the interface of the bubbles and the liquid films and providing a barrier to coalescence of the bubbles. It is typically more challenging to form foams in organic liquids than to form aqueous foams. Some fluorinated surfactants are known to produce stable foams in organic liquids. Recently, however, there has been an industry trend away from using fluorinated surfactants.

Certain silicone surfactants have been reported as useful for foaming organic liquids in U.S. Pat. No. 4,415,615 (Esmay et al.). On the other hand, silicone MQ resins have been reported to be defoaming agents in U.S. Pat. No. 6,207,722 (Juen et al.) and in brochure “Your Technology-Siltech Chemistry”, published by Siltech Corporation, Toronto, Canada, published August 2016.

Inorganic particles are included in many foam compositions for a variety of reasons. Some of these particles function as nucleating agents. Other particles act as filler to alter the physical properties of the composition, for example, altering the rheology of the composition. Still other particles, hydrophobic fumed silica for example, have been found to function as defoaming agents. Fumed silica, which is also known as pyrogenic silica, consists of primary particles that are irreversibly bonded together in the form of aggregates, which have an average size of from 200 nm to 300 nm. U.S. Pat. No. 6,586,483 (Kolb et al.) reports a foam composition that includes surface-modified nanoparticles having a particle diameter of about 100 nanometers or less. U.S. Pat. No. 7,141,612 (Baran, Jr., et al.) reports a foam composition that includes surface-modified organic molecules such as fullerenes, dendrimers, organic polymeric microspheres, and combinations thereof.

### SUMMARY

We now report that compositions that include surface-modified nanoparticles are capable of forming a persistent foam in the presence of a silicone MQ resin and or a poly(alkyleneoxide)-modified polydimethylsiloxane. Compositions that include surface-modified nanoparticles and a silicone MQ resin surprisingly are capable of forming a persistent foam even though silicone MQ resins have been reported to be defoaming agents. In some embodiments, compositions that include surface-modified nanoparticles and a poly(alkyleneoxide)-modified polydimethylsiloxane are surprisingly more capable of forming a persistent foam than compositions that include surface-modified nanoparticles and other surfactants. In some embodiments, compositions that include surface-modified nanoparticles and a poly(alkyleneoxide)-modified polydimethylsiloxane are surprisingly more capable of forming a persistent foam than compositions that include either the surface-modified nanoparticles or the poly(alkyleneoxide)-modified polydimethylsiloxane alone.

In one aspect, the present disclosure provides a foam composition that includes a vehicle, surface-modified nanoparticles having a particle diameter of not more than 100 nanometers, and at least one of a silicone MQ resin or a poly(alkyleneoxide)-modified polydimethylsiloxane. In some embodiments, the foam composition has voids therein. The present disclosure provides the composition before it is foamed, upon foaming, and after it is foamed.

In another aspect, the present disclosure provides a foam composition that includes a vehicle, surface-modified nanoparticles having a particle diameter of not more than 100 nanometers, and a silicone MQ resin. In some embodiments, the foam composition has voids therein. The present disclosure provides the composition before it is foamed, upon foaming, and after it is foamed.

In another aspect, the present disclosure provides an adhesive tape (for example, a pressure-sensitive adhesive tape) including an above-described foam composition.

In another aspect, the present disclosure provides an article that includes an above-described foam composition. The article can be, for example, a gasket or automobile body molding.

In another aspect, the present disclosure provides a process for making the above-described foam composition that includes introducing a foaming agent into a composition that includes the vehicle, the surface-modified nanoparticles having a particle diameter of not more than 100 nanometers, and at least one of the silicone MQ resin or the poly(alkyleneoxide)-modified polydimethylsiloxane to form voids in the composition.

In another aspect, the present disclosure provides a process of making a tape where the process includes foaming a composition that includes a vehicle, surface-modified nanoparticles having a particle diameter of not more than 100 nanometers, and at least one of a silicone MQ resin or poly(alkyleneoxide)-modified polydimethylsiloxane and subsequently applying the composition to a substrate.

As used herein:

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5).

The term “acrylic” refers to both acrylic and methacrylic polymers, oligomers, and monomers.

The term “(meth)acrylate” with respect to a monomer, oligomer, or polymer means a vinyl-functional alkyl ester formed as the reaction product of an alcohol with an acrylic or a methacrylic acid. “(Meth)acrylate” includes, separately and collectively, methacrylate and acrylate.

“Alkyl group” and the prefix “alk-” are inclusive of both straight chain and branched chain groups having up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above.

“Arylalkylene” refers to an “alkylene” moiety to which an aryl group is attached.

“Aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups, examples of which include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

A “monomer unit” of a polymer or oligomer is a segment of a polymer or oligomer derived from a single monomer.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked. Thermoset polymers are crosslinked.

The term “surface-modified nanoparticle” refers to a particle that includes surface groups attached to the surface of the particle. The surface groups modify the character of the particle.

The term “persistent foam” refers to the presence of gas voids in a composition for a period of at least five minutes after the composition has been foamed.

The terms “particle diameter” and “particle size” refer to the maximum cross-sectional dimension of a particle. If the particle is present in the form of an aggregate, the terms “particle diameter” and “particle size” refer to the maximum cross-sectional dimension of the aggregate.

The term “ceramic” refers to glasses, crystalline ceramics, glass-ceramics, and combinations thereof.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### DETAILED DESCRIPTION

The foam composition of the present disclosure and/or useful in the processes of the present disclosure includes surface-modified nanoparticles having a particle diameter of less than 100 nanometers, disposed in a vehicle. In some embodiments, the foam composition includes voids in the vehicle, which may be present at the surface of the composition, dispersed throughout the composition, or a combination thereof. For some applications, the voids are dispersed uniformly throughout the composition. The voids generally include at least one gas; therefore, they may be referred to as gas voids or bubbles. In some embodiments, the foam composition includes a cellular structure in which the voids are in the form of closed cells. In some embodiments, the foam composition is an open cell foam.

The surface-modified nanoparticles useful in the foam compositions and processes disclosed herein are individual, unassociated (that is, non-aggregated) nanoparticles dispersed throughout the vehicle and do not irreversibly associate with each other. The term “associate with” or “associating with” includes, for example, covalent bonding, hydrogen bonding, electrostatic attraction, London forces, and hydrophobic interactions. The surface-modified nanoparticles are selected such that the foam composition is free from a degree of particle agglomeration or aggregation that would interfere with the desired properties of the composition including the ability of the composition to foam.

The surface-modified nanoparticles useful in the foam compositions and processes of the present disclosure may be selected to be compatible with the vehicle to be foamed. For vehicles that include a variety of components, the surface-modified nanoparticles may be selected to be compatible with at least one component of the vehicle. For transparent vehicles, one useful method of assessing the compatibility of the surface-modified nanoparticles with the transparent vehicle includes combining the surface-modified nanoparticles and the vehicle and observing whether the surface-modified nanoparticles appear to dissolve in the vehicle such that the resulting composition is transparent. The nature of the inorganic particle component of the surface-modified particle will prevent the surface-modified particle from actually dissolving in the vehicle, that is, the surface-modified nanoparticles will be dispersed in the vehicle; however, the compatibility of the surface groups with the vehicle will give the surface-modified nanoparticles the appearance of dissolving in the vehicle. As the size of the surface-modified nanoparticles increases, the haziness of the vehicle generally increases. Surface-modified nanoparticles may be selected such that they do not settle out of the vehicle.

The surface-modified nanoparticles useful in the foam compositions and processes of the present disclosure have surface groups that modify the solubility characteristics of the nanoparticles. The surface groups are selected to render the particle compatible with the vehicle or at least a component of the vehicle, in which the particle is disposed such that the resulting composition, upon foaming, forms a persistent foam. When the composition is polymerizable, for example, the surface groups can be selected to associate or react with at least one component of the vehicle to become part of the polymer network of the composition.

Suitable surface groups can also be selected based upon the solubility parameter of the surface group and the vehicle. The surface group, or the agent from which the surface group is derived, may be selected to have a solubility parameter similar to the solubility parameter of the vehicle to be foamed. When the vehicle to be foamed is hydrophobic, for example, one skilled in the art can select from among various hydrophobic surface groups to achieve a surface-modified particle that is compatible with the hydrophobic vehicle. Similarly, when the vehicle to be foamed is hydrophilic, one skilled in the art can select from hydrophilic surface groups. The particle can also include at least two different surface groups that combine to provide a nanoparticle having a solubility parameter that is similar to the solubility parameter of the vehicle.

The surface groups may be selected to provide a statistically averaged, randomly surface-modified nanoparticle. The surface groups are present on the surface of the nanoparticle in an amount sufficient to provide surface-modified nanoparticles that are capable of being subsequently dispersed in the vehicle without aggregation. The surface groups may be present in an amount sufficient to form a monolayer, in some embodiments, a continuous monolayer, on the surface of the nanoparticle.

Surface modifying groups may be derived from surface modifying agents. Schematically, surface modifying agents can be represented by the formula A-B, where the A group is capable of attaching to the surface of the nanoparticle, and the B group is a compatibilizing group that may be reactive or non-reactive with the vehicle or other component of the composition. Compatibilizing groups can be selected to render the nanoparticle relatively more polar than the nanoparticle before treatment, relatively less polar than the nanoparticle before treatment, or relatively non-polar. In some embodiments, B is alkyl, alkenyl, arylalkylenyl, alkylarylenyl, or aryl, wherein alkyl, alkenyl, arylalkylenyl, alkylarylenyl, and aryl are optionally at interrupted by at least one ether, thioether, amine, amide, ester, thioester, carbonate, thiocarbonate, carbamate, thiocarbamate, urea, thiourea, or combination thereof and optionally terminated by an acrylate, a methacrylate, an acrylamide, a methacrylamide, a styrenyl, or a terminal alkenyl group (e.g., vinyl). In some embodiments, A is hydroxyl (e.g., —OH), a sulfonic acid group (i.e., —SO₃M), a phosphonic acid group (i.e., —PO₃M), carboxylic acid group (—CO₂M), amino (—NH₂ or —N(H)alkyl), epoxy, or silane (—Si(Y)ₓ(Z)₃₋ₓ). For any of the embodiments in which W is an acid group (e.g., a carboxylic acid, sulfonic acid, or phosphonic acid), M is hydrogen, a free anion, or a counter cation. Examples of useful counter cations include alkali metal ions (e.g., sodium, potassium, and lithium), alkaline earth metal ions (e.g., calcium and magnesium), ammonium, and alkyl ammonium (e.g., dialkylammonium, trialkylammonium, and tetraalkylammonium wherein alkyl is optionally substituted by hydroxyl, fluoride, or aryl). Free anions on the acid group are possible, for example, when the acid has an ionic interaction with the surface of the nanoparticle, as described in further detail below. For any of the embodiments in which A is a silane (—Si(Y)ₓ(Z)₃₋ₓ), each Y is independently a non-hydrolyzable group (e.g., any R group described below), each Z is independently a halide (i.e., fluoride, chloride, bromide, or iodine), hydroxyl (i.e., —OH), alkoxy (e.g., —O-alkyl), aryloxy (e.g., —O-aryl), or acyloxy (e.g., —O—C(O)— alkyl), amino (e.g., —N(R^{A})(R^{B}), polyalkyleneoxy; and oxime (e.g., —O—N—C—(R^{A})(R^{B}), wherein each R^{A} or R^{B} is independently hydrogen or alkyl), wherein alkoxy and acyloxy are optionally substituted by halogen, and aryloxy is optionally substituted by halogen, alkyl (e.g., having up to 4 carbon atoms), or haloalkyl, and x is 0 or 1. In some embodiments, alkoxy and acyloxy have up to 6 (or up to 4) carbon atoms. In some embodiments, aryloxy has 6 to 12 (or 6 to 10) carbon atoms. In some embodiments, Z can also be —O-covalently bonded to the surface of the nanoparticle.

Examples of suitable classes of surface-modifying agents include silanes, organic acids, organic bases, and alcohols. Examples of useful silanes include organosilanes including alkylchlorosilanes, alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltriphenoxysilane, vinyltri(t-butoxy)silane, vinyltris(isobutoxy)silane, vinyltris(isopropenoxy)silane and vinyltris(2-methoxyethoxy)silane); N-(3-triethoxysilylpropyl)methoxyethoxyethoxy ethyl carbamate; N-(3-triethoxysilylpropyl) methoxyethoxyethoxyethyl carbamate; silane functional (meth)acrylates (e.g., 3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, methacryloyloxymethyltriethoxysilane, methacryloyloxymethyltrimethoxysilane, 3-(methacryloyloxy)propyldimethylethoxysilane, and 3-(methacryloyloxy)propenyltrimethoxysilane); polydialkylsiloxanes including, for example, polydimethylsiloxane, arylsilanes including, for example, substituted and unsubstituted arylsilanes, alkylsilanes including, for example, substituted and unsubstituted alkyl silanes including, for example, methoxy and hydroxy substituted alkyl silanes, and combinations thereof. Methods of surface-modifying silica using silane functional (meth)acrylates are described, for example, in U.S. Pat. No. 4,491,508 (Olsen et al.), U.S. Pat. No. 4,455,205 (Olsen et al.), U.S. Pat. No. 4,478,876 (Chung), U.S. Pat. No. 4,486,504 (Chung), and U.S. Pat. No. 5,258,225 (Katsamberis).

Useful organic acid surface-modifying agents include oxyacids of carbon (e.g., carboxylic acid), sulfur, and phosphorus, and combinations thereof. Examples of polar surface-modifying agents having carboxylic acid functionality include CH₃O(CH₂CH₂O)₂CH₂COOH (hereafter MEEAA) and 2-(2-methoxyethoxy) acetic acid having the chemical structure CH₃OCH₂CH₂OCH₂COOH (hereafter MEAA) and mono(polyethylene glycol) succinate. Examples of non-polar surface-modifying agents having carboxylic acid functionality include octanoic acid, dodecanoic acid, and oleic acid. Examples of suitable phosphorus containing acids include phosphonic acids (e.g., octylphosphonic acid, laurylphosphonic acid, decylphosphonic acid, dodecylphosphonic acid, and octadecylphosphonic acid). Useful organic base surface-modifying agents include alkylamines (e.g., octylamine, decylamine, dodecylamine and octadecylamine). Examples of suitable surface-modifying alcohols include aliphatic alcohols (e.g, octadecyl, dodecyl, lauryl, and furfuryl alcohol), alicyclic alcohols such as cyclohexanol, and aromatic alcohols (e.g., phenol, benzyl alcohol, and combinations thereof). Examples of other useful non-silane surface modifying agents include acrylic acid, methacrylic acid, beta-carboxyethyl acrylate, mono-2-(methacryloyloxyethyl) succinate, and combinations thereof. A useful surface modifying agent that imparts both polar character and reactivity to the nanoparticles is mono(methacryloyloxypolyethyleneglycol) succinate.

When the vehicle includes aromatic ring containing-epoxy resins, useful surface-modifying groups can include an aromatic ring. Examples of surface-modifying groups particularly suitable for epoxy resin compositions are disclosed in U.S. Pat. No. 5,648,407 (Goetz et al.).

A variety of methods are available for modifying the surface of nanoparticles including adding a surface modifying agent to nanoparticles (e.g., in the form of a powder or a colloidal dispersion) and allowing the surface modifying agent to react with the nanoparticles. Other useful surface modification processes are described in, for example, U.S. Pat. No. 2,801,185 (Iler) and 4,522,958 (Das et al.).

In some embodiments, the nanoparticles useful for practicing the present disclosure are inorganic. Examples of suitable inorganic nanoparticles include silica and metal oxide nanoparticles including zirconia, titania, ceria, alumina, iron oxide, vanadia, antimony oxide, tin oxide, alumina/silica, and combinations thereof. The nanoparticles have an average particle diameter not more than 100 nm, in some embodiments, not more than 50 nm, and in some embodiments, from 3 nm to 100 nm, from 3 nm to 50 nm, from 3 nm to 20 nm, or from 5 nm to 10 nm. If the nanoparticles are aggregated, the maximum cross-sectional dimension of the aggregated particle is within any of these ranges.

In some embodiments, surface-modified zirconia nanoparticles include a combination of oleic acid and acrylic acid adsorbed onto the surface of the particle. Useful surface-modified silica nanoparticles include silica nanoparticles surface-modified with silane surface modifying agents such as 3-acryloyloxypropyl trimethoxysilane, 3-methacryloyloxypropyltrimethoxysilane, 3-mercaptopropyltrimethoxysilane, n-octyltrimethoxysilane, isooctyltrimethoxysilane, and combinations thereof. Silica nanoparticles can be treated with a number of surface modifying agents including alcohols, organosilanes such as any of those described above, and combinations thereof and organotitanates and mixtures thereof.

The nanoparticles may be in the form of a colloidal dispersion. Examples of useful commercially available unmodified silica starting materials include nano-sized colloidal silicas available under the product designations NALCO 1040, 1050, 1060, 2326, 2327, and 2329 colloidal silica from Nalco Chemical Co., Naperville, IL. Useful metal oxide colloidal dispersions include colloidal zirconium oxide, suitable examples of which are described in U.S. Pat. No. 5,037,579 (Matchett), and colloidal titanium oxide, useful examples of which are described in U.S. Pat. No. 6,329,058 (Arney et al.).

In some embodiments, the nanoparticles useful for practicing the present disclosure are organic. Specific examples of useful surface-modified organic molecules include alkylated buckminsterfullerenes (fullerenes) and alklylated polyamidoamine (PAMAM) dendrimers. Specific examples of fullerenes include C₆₀, C₇₀, C₈₂, and C₈₄. Specific examples of PAMAM dendrimers include those of Generations 2 through 10 (G2 to G10) available from Millipore Sigma, St. Louis, Missouri. PAMAM dendrimers are currently commercially available with primary amine, hydroxyl, carboxylate sodium salt, mixed amine/hydroxyl, and C₁₂ surface functional groups. The alkyl groups on the organic molecules may be straight or branched and may range from at least C₃ to not greater than C₃₀ and may be any size or range in between C₃ and C₃₀. For example, the ranges may be C₃ to C₂₂; C₃ to C₁₈; C₃ to C₁₂; or C₃ to C₈, and any combination or integer therebetween.

Another example of a suitable organic nanoparticle is a polymeric microsphere. Specific examples of a useful organic polymeric microspheres include microspheres that comprise polystyrene, available from Bangs Laboratories, Inc., Fishers, Ind., as powders or dispersions. Average particle sizes of the polystyrene microspheres range from at least 20 nm to not more than 60 nm. Current commercially available average particle sizes are 20, 30, 50, and 60 nm.

Various methods may be employed to combine the surface-modified nanoparticles and the vehicle. For example, a colloidal dispersion of surface-modified nanoparticles and vehicle can be combined. Solvent present in the composition is then removed, leaving the surface-modified nanoparticles dispersed in the vehicle. The solvent may be removed by evaporation (e.g., distillation, rotary evaporation, or oven drying). Optionally, for some colloidal dispersions such as aqueous colloidal dispersions, before addition of the vehicle, a cosolvent (e.g., methoxy-2-propanol or N-methylpyrrolidone) may be added to the colloidal dispersion to assist removal of water. After the vehicle is added, the water and cosolvent are removed.

Another method for incorporating colloidal dispersions of surface-modified nanoparticles into a vehicle includes drying the colloidal dispersion of surface-modified nanoparticles to a powder followed by addition of the vehicle or at least one component of the vehicle into which the nanoparticles are to be dispersed. The drying step may be accomplished by conventional means such as oven drying or spray drying. The surface-modified nanoparticles may be designed to have a sufficient amount of surface groups to prevent irreversible agglomeration or irreversible aggregation upon drying. The drying time and the drying temperature can be minimized for nanoparticles having less than 100% surface coverage.

Surface-modified nanoparticles can be added to the vehicle in any amount sufficient to provide a composition capable of foaming, in some embodiments, in any amount sufficient to provide a composition capable of forming a persistent foam. In some embodiments, the surface-modified nanoparticles are present in the foam composition in a range from 0.1 weight percent to 10 weight percent, based on the total weight of the foam composition. In some embodiments, the surface-modified nanoparticles are present in the foam composition in a range from 0.1 weight percent to 5 weight percent, or in a range from in a range from 0.5 weight percent to 3 weight percent, based on the total weight of the foam composition. The surface-modified nanoparticles may be present in the foam composition in an amount of at least 0.1, 0.2, 0.3, 0.4, or 0.5 weight percent and up to 10, 5, 4, or 3 weight percent, based on the total weight of the foam composition. In some embodiments, the surface-modified nanoparticles are dispersed throughout the vehicle, in some embodiments, dispersed homogeneously throughout the vehicle.

In some embodiments, the foam composition of the present disclosure or made by the process of the present disclosure includes a silicone MQ resin. A silicone MQ resin is an organosilicon polymer made from structural units referred to as M units represented by formula (R)₃SiO_{1/2} and Q units represented by formula SiO_{4/2}, in which Si is silicon, O is oxygen and R is either hydrogen or an aliphatic or aromatic organic group. Thus, silicone MQ resins comprise silicon atoms bonded to one oxygen atom and silicon atoms bonded to four oxygen atoms. A representative structure of a silicone MQ resin is shown in formula I, below.

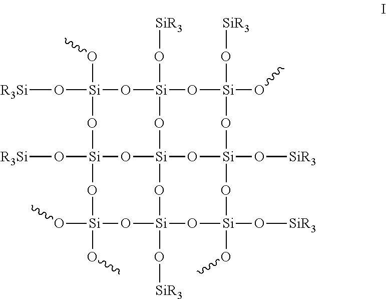

Suitable R substituents include hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated-O—, —NH—, —N(alkyl)-, —S—, —Si—, or combination thereof, and wherein aryl, arylene, and heterocyclylene are unsubstituted or substituted by at least one alkyl, alkoxy, halogen, or combination thereof. R groups can be selected independently from each other. In some embodiments, each R group is the same. In some embodiments, R is not fluorinated. In some embodiments, R is not halogenated. In some embodiments, R is not hydrogen. In some embodiments, each R is independently hydrogen, alkyl, aryl, or alkyl at least one of interrupted by at least one catenated —O— group or arylene or terminated by aryl. Suitable alkyl groups for R typically have 1 to 20, 1 to 18, 1 to 12, 1 to 10, 1 to 6, or 1 to 4 carbon atoms. Examples of useful alkyl groups include methyl, ethyl, isopropyl, n-propyl, n-butyl, iso-butyl, and octadecyl. In some embodiments, each R is independently alkyl having up to 18 (in some embodiments, up to 4, 3, or 2) carbon atoms, phenyl, benzyl, or C₆H₅C₂H₄—. In some embodiments, each R is independently methyl, phenyl, C₆F₁₃C₂H₄—, or octadecyl. In some embodiments, each R is independently alkyl. In some embodiments, each R is independently methyl or phenyl. In some embodiments, each R is methyl; in these embodiments, the silicone MQ resin comprises methyl groups. In some embodiments, the silicone MQ resin is not fluorinated. In some embodiments, the silicone MQ resin is not halogenated.

The ratio of the M units to Q units influences the properties of a silicone MQ resin. Silicone MQ resins that have a M:Q ratio greater than 1 are typically liquids at room temperature. Silicone MQ resins that have a M:Q ratio of 1 or lower are typically solids at room temperature. In some embodiments, the silicone MQ resin has an M:Q ratio of at least 0.3:1, 0.4:1, 0.5:1, 0.6:1, 0.7:1, 0.8:1, 0.9:1, 1:1, 1.1:1, 1.2:1, 1.3:1, 1.4:1, or 1.5:1. In some embodiments, the silicone MQ resin has an M:Q ratio of at least 0.8:1, 0.9:1, 1:1, 1.1:1, or 1.2:1. The maximum M:Q ratio is 4:1. For silicone MQ resins, the M:Q ratio is typically not more than 3:1, in some embodiments, not more than 2.9:1, 2.8:1, 2.7:1, 2.6:1, 2.5:1, 2.4:1, 2.3:1, 2.2:1, 2.1:1, or 2:1. For the purposes of this disclosure, the M:Q ratio is determined by NMR spectroscopy using the method described in the Examples, below.

A silicone MQ resin can be prepared by a reaction of a one or more compounds represented by formula (R)₃—Si—R¹ and one or more compounds represented by formula (R¹)₄Si, wherein R is as defined above in any of its embodiments, and R¹ is a hydrolyzable group. The term “hydrolyzable group” refers to a group that can react with water under conditions of atmospheric pressure. The reaction with water may optionally be catalyzed by acid or base. Suitable hydrolyzable groups include halogen (e.g., iodo, bromo, chloro); alkoxy (e.g., —O-alkyl), aryloxy (e.g., —O-aryl), acyloxy (e.g., —O—C(O)-alkyl), amino (e.g., —N(R^{A})(R^{B}), polyalkyleneoxy; and oxime (e.g., —O—N═C—(R^{A})(R^{B}), wherein each R^{A} or R^{B} is independently hydrogen or alkyl). In some embodiments, each R¹ is independently halogen or alkoxy optionally substituted by halogen. In some embodiments, each R¹ is independently chloro or alkoxy having up to 12 (or up to 6 or 4) carbon atoms. In In some embodiments, each R¹ is independently methoxy or ethoxy. When the compounds of formula (R)₃—Si—R¹ and (R¹)₄Si react, R¹ is converted to a hydrolyzed group, such as —OH, during hydrolysis. The Si—OH groups react with each other to form silicone-oxygen linkages. Hydrolysis and condensation can be carried out by conventional methods, for example, by heating the compound of formula R—Si(R¹)₃ and optionally R²—Si(R¹)₃ in water optionally in the presence of acid or base.

After hydrolysis and condensation, typically-OH groups are present in the silicone MQ resin. The —OH groups can be further reacted with an end-capping agent to convert the hydrolyzed group, e.g., —OH, to —OSi(R)₃. Suitable end-capping agents include those having formulas R¹—Si(R)₃ and O[Si(R)₃]₂, wherein R¹ is as defined above in any of its embodiments, for example. Suitable end-capping agents also include those having formulas H—Si(R)₃, which can react with hydroxyl groups in the present of transition metal catalysts (e.g., palladium and platinum catalysts). The silicone MQ resin comprises further groups having the formula —Si(R)₃ after end-capping, wherein R is as defined above in any of its embodiments, independently from other R groups in the silicone MQ resin. In some embodiments, the silicone MQ resin has a hydroxyl content in a range from 185 to 1840 milliequivalents per kilogram (meq/kg). In some embodiments, the silicone MQ resin has a hydroxyl content in a range from 500 to 1000 milliequivalents per kilogram (meq/kg). For the purposes of this disclosure, the hydroxyl content is determined by NMR spectroscopy using the method described in the Examples, below, for the determining the MQ ratio.

Depending on M:Q stoichiometry, synthetic preparation, and end-capping, silicone MQ resins can take a variety of polycyclic structures and have a variety of properties, including solubility in organic vehicles. Although formula I is shown as having an organized structure at least in the central portion, it should be understood that the silicone MQ resin may have a more random structure. Thus, silicone MQ resins useful for practicing the present disclosure include three-dimensional and branched random copolymers.

Silicone MQ resins can be obtained from a variety of commercial sources, for example, from Siltech, Corporation, Toronto, Ontario, Canada, under the trade designation “SILMER Q”; from Dow Chemical Company, Midland, Michigan, under the trade designation “DOWSIL”, from Wacker Chemie, Munich, Germany, from Momentive Performance Materials, Waterford, New York, under the trade designation “SILGRIP”, from BYK-Chemie, Wesel, Germany, and from Gelest, Inc., Morrisville, Pennsylvania. Silicone MQ resins have been reported to provide release properties, lubricity, tack, softness, and/or repellency. Additionally, MQ resins are explicitly reported as “defoamers” and “antifoamers”. Silicone MQ resins are generally not known as surfactants. In some embodiments, the silicone MQ resins are free of alkyloxy groups such as those represented by formula —(OR²)ₙ—OR³, in which n, R², and R³ are as defined below in any of their embodiments.

In some embodiments, the foam composition of the present disclosure or made by the process of the present disclosure includes a poly(alkyleneoxide)-modified polydimethylsiloxane. A polydimethylsiloxane is an organosilicon polymer made from structural units referred to as D units represented by formula (R)₂SiO_{2/2}, in which Si is silicon, O is oxygen and R is a methyl group. In some embodiments, the poly(alkyleneoxide)-modified polydimethylsiloxane is not fluorinated. In some embodiments, the poly(alkyleneoxide)-modified polydimethylsiloxane is not halogenated. Polydimethylsiloxanes include repeating divalent units represented by formula II:

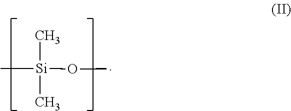

A poly(alkyleneoxide)-modified polydimethylsiloxane further includes terminal units represented by formula -Q-(OR²)ₙ—OR³, divalent units represented by formula III:

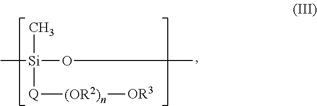

or a combination thereof, wherein each Q is independently alkylene, arylene, or alkylene that is at least one of interrupted or terminated by aryl, each of which is optionally at least one of interrupted or terminated by at least one ether (i.e., —O—), thioether (i.e., —S—), amine (i.e., —NR⁴—), amide (i.e., —N(R⁴)—C(O)— or —C(O)—N(R⁴)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R⁴)N—C(O)—O— or —O—C(O)—N(R⁴)—, thiocarbamate (i.e., —N(R⁴)—C(O)—S— or —S—C(O)—N(R⁴)—, urea (i.e., —(R⁴)N—C(O)—N(R⁴)—), thiourea (i.e., —(R⁴)N—C(S)—N(R⁴)). In any of these groups that include an R⁴, R⁴ is hydrogen, alkyl, aryl, or arylalkylenyl, wherein aryl and arylalkylenyl are unsubstituted or substituted by at least one alkyl, alkoxy, or combination thereof. In some embodiments, R⁴ is hydrogen or alkyl, for example, having 1 to 4 carbon atoms (e.g., methyl, ethyl, n-propyl, isopropyl, n-butyl, isobutyl, or sec-butyl). In some embodiments, R⁴ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—). In some embodiments, Q is alkylene having 1 to 10, 1 to 6, 1 to 4, 1 to 3, or 1 to 2 carbon atoms. For suitable poly(alkylene oxide) groups, each OR² is independently —OCH₂CH₂—, —OCH(CH₃) CH₂—, —OCH₂CH₂CH₂—, —OCH₂CH(CH₃)—, —OCH₂CH₂CH₂CH₂—, —OCH(CH₂CH₃) CH₂—, —OCH₂CH(CH₂CH₃)—, and —OC(CH₃) 2CH₂—. In some embodiments, each OR² is independently —OCH₂CH₂—, —OCH(CH₃) CH₂— or —OCH₂CH(CH₃)—. In some embodiments, each OR² is independently —OCH₂CH₂—. Each n is independently a value from 5 to 300 (in some embodiments, from 10 to about 250, or from 20 to about 200). For suitable poly(alkylene oxide) groups, each R³ is hydrogen, alkyl, acyl, aryl, or arylalkylenyl, wherein aryl and arylalkylenyl are unsubstituted or substituted by at least one alkyl, alkoxy, or combination thereof. In some embodiments, R³ is hydrogen, alkyl, for example, having 1 to 4 carbon atoms (e.g., methyl, ethyl, n-propyl, isopropyl, n-butyl, isobutyl, or sec-butyl), or acyl, for example, having 2 to 4 carbon atoms (e.g., acetyl, propionyl, or butyryl). In some embodiments, R³ is acetyl, methyl, or hydrogen. In some embodiments, R³ is hydrogen or acetyl.

In some embodiments, the poly(alkyleneoxide)-modified polydimethylsiloxane useful in the foam composition of the present disclosure can be represented by formula IV:

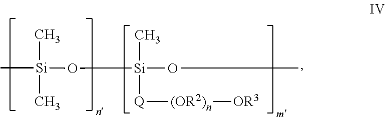

which may or may not include a terminal unit represented by formula -Q-(OR²)ₙ—OR³, wherein each R², R³, Q, and n are independently as defined above in any of their embodiments, and n′+m′ is in a range from 10 to 500, 10 to 400, 10 to 300, 12 to 300, 13 to 300, 13 to 200, 10 to 100, 10 to 50, or 10 to 30. Such values of n′+m′ provide poly(alkyleneoxide)-modified polydimethylsiloxanes having number average molecular weights of up to about 50,000, 40,000, 30,000, 25,000, 15,000, 10,000, or 5,000 grams per mole. Typically, the ratio of n′ to m′ is greater than 1:1 (in some embodiments, at least 2:1 or 3:1, or 5:1). In some embodiments, the poly(alkyleneoxide)-modified polydimethylsiloxane as described herein in any of its embodiments has a number average molecular weight of at least 750 grams per mole, at least 900 grams per mole, or at least 1000 grams per mole. In some embodiments, the poly(alkyleneoxide)-modified polydimethylsiloxane as described herein in any of its embodiments has a number average molecular weight of not more than 50,000, 40,000, 30,000, 25,000, 15,000, 10,000, or 5,000 grams per mole. Polysiloxanes disclosed herein typically have a distribution of molecular weights. Although formula IV is shown as a block copolymer, it should be understood that the divalent units of formulas II and III can be randomly positioned in the copolymer. Thus, polysiloxanes useful for practicing the present disclosure also include random copolymers.

The number of repeating units and the molecular weights of polysiloxanes can be determined, for example, by nuclear magnetic resonance (NMR) spectroscopy using techniques known to one of skill in the art. Molecular weights, particularly for higher molecular-weight materials, including number average molecular weights and weight average molecular weights, can also be measured, for example, by gel permeation chromatography (i.e., size exclusion chromatography) using techniques known to one of skill in the art. For the purposes of this disclosure, the number average molecular weight of the poly(alkyleneoxide)-modified polydimethylsiloxane is determined by NMR spectroscopy using the method described in the Examples, below.

In some embodiments, the silicone MQ resin, the poly(alkyleneoxide)-modified polydimethylsiloxane, or a combination thereof is present in the foam composition in a range from 0.1 weight percent to 10 weight percent, based on the total weight of the foam composition. In some embodiments, the silicone MQ resin, the poly(alkyleneoxide)-modified polydimethylsiloxane, or a combination thereof is present in the foam composition in a range from 0.1 weight percent to 5 weight percent, or in a range from in a range from 0.5 weight percent to 3 weight percent, based on the total weight of the foam composition. The silicone MQ resin, the poly(alkyleneoxide)-modified polydimethylsiloxane, or a combination thereof may be present in the foam composition in an amount of at least 0.1, 0.2, 0.3, 0.4, or 0.5 weight percent and up to 10, 5, 4, or 3 weight percent, based on the total weight of the foam composition. Advantageously, when the silicone MQ resin, the poly(alkyleneoxide)-modified polydimethylsiloxane, or a combination thereof is used in combination with surface-modified nanoparticles, a lower amount of the silicone MQ resin, the poly(alkyleneoxide)-modified polydimethylsiloxane, or combination thereof can be useful for increasing foam height and/or stabilizing the foam composition. In some embodiments, the foam composition is free of fluorinated surfactant.

The vehicle of the foam composition can include a variety of components and may be in the form of a solid, liquid, or a combination thereof. The vehicle may be selected based upon the desired properties of the foam composition (e.g., tack, stiffness, hardness, density, volume, transparency, flexibility, conformability, resilience, creep, strength, modulus, elongation, chemical resistance, temperature resistance, environmental resistance, and compressibility). In some embodiments, at the time of foaming, the vehicle is a liquid and may be, for example a solution, an emulsion, a suspension, a dispersion, a syrup, or a melt. In some embodiments, the vehicle is an organic liquid. Useful examples of organic liquids include acids, alcohols, ketones, aldehydes, amines, ethers, hydrocarbons, halocarbons, monomers, oligomers, and polymers.

In some embodiments, the vehicle includes water. In some embodiments, the vehicle excludes water. In some embodiments, the foam composition comprises not more than 50, 40, 30, 20, 10, 5, or 1 percent by weight water.

Examples of useful organic vehicles include organic polymers. Organic polymers suitable for the vehicle include natural and synthetic rubber resins including thermosettable rubbers as well as thermoplastic rubbers and elastomers such as nitrile rubbers (e.g, acrylonitrile-butadiene), polyisoprene rubber, polychloroprene rubber, polybutadiene rubber, butyl rubber, ethylene-propylene-diene monomer rubbers (EPDM), Santoprene® polypropylene-EPDM elastomers, ethylene-propylene rubber, styrene-butadiene copolymers, styrene-isoprene copolymers, styrene-butadiene-styrene rubber, styrene-isoprene-styrene rubber, styrene-ethylene-butylene-styrene rubber, styrene-ethylene-propylene-styrene rubber, polyisobutylene rubber, ethylene vinyl acetate rubbers, silicone rubbers (e.g., polysiloxanes), polymethacrylate rubbers, polyacrylate rubbers (e.g., copolymers of isooctyl acrylate and acrylic acid), polyesters, polyether esters, polyvinyl ethers, polyurethanes, and blends and copolymers thereof. Useful copolymers include linear, radial, star and tapered block copolymers and combinations thereof.

Other elastomers suitable for the vehicle include fluoroelastomers (e.g., polytrifluoroethylene, polyvinylidene fluoride, hexafluoropropylene, and fluorinated ethylene-propylene copolymers), fluorosilicones and chloroelastomers (e.g., chlorinated polyethylene), and combinations thereof.

Further examples of organic polymers suitable for the vehicle include thermoplastic resins such as polyacrylonitrile, acrylonitrile-butadiene-styrene, styrene-acrylonitrile, cellulose, chlorinated polyether, ethylenevinylacetate, fluorocarbons (e.g., polychlorotrifluoroethylene, polytetrafluoroethylene, fluorinated ethylene-propylene, and polyvinylidene fluoride), polyamides (e.g., polycaprolactam, polyhexamethylene adipamide, polyhexamethylene sebacamide, polyundecanoamide, polylauroamide and polyacrylamide), polyimides (e.g., polyetherimide), polycarbonate, polyolefins (e.g., polyethylene, polypropylene, polybutene and poly-4-methyl pentene), polyalkylene terephthalates (e.g., polyethyleneterephthalate), polyalkylene oxides (e.g., polyphenylene oxide), polystyrene, polyurethane, polyisocyanurates, vinyl polymers (e.g., polyvinyl chloride, polyvinyl acetate, polyvinyl alcohol, polyvinyl butyral, polyvinylpyrrolidone, polyvinylidene chloride), and combinations thereof.

Further examples of organic polymers suitable for the vehicle include thermosettable resins such as polyesters and polyurethanes and hybrids and copolymers thereof including acylated urethanes and acylated polyesters, amino resins (e.g., aminoplast resins, alkylated urea-formaldehyde resins, melamine-formaldehyde resin), acrylate resins (e.g., polyacrylates and polymethacrylates, vinyl acrylates, acrylated epoxies, acrylated urethanes, acrylated polyesters, acrylated acrylics, acrylated polyethers, acrylated oils and acrylated silicones), alkyd resins such as urethane alkyd resins, polyester resins, reactive urethane resins, phenolic resins (e.g., resole resins, novolac resins and phenol-formaldehyde resins), phenolic/latex resins, epoxy resins (e.g., bisphenol epoxy resins, aliphatic and cycloaliphatic epoxy resins, epoxy/urethane resin, epoxy/acrylate resin and epoxy/silicone resin), isocyanate resins, isocyanurate resins, polysiloxane resins such as alkylalkoxysilane resins, reactive vinyl resins, and mixtures thereof.

In some embodiments, the vehicle comprises at least one of an isocyanate, a polyurethane, or a polyurea. A wide variety of isocyanates and polyols and polyurethanes made therefrom can be used in the foam composition of the present disclosure. In some embodiments, the foam composition is a polyurethane foam and the process for making the foam composition is a process for making a polyurethane foam.

In some embodiments, the vehicle is not a silicone polymer. In some embodiments, the vehicle comprises an organic polymer that is other than a silicone-containing polymer. In some embodiments, the vehicle comprises an organic polymer that is other than an acrylated silicone, a silicone-containing polyurethane, or epoxy/silicone resin.

The vehicle may be selected to provide an adhesive composition including pressure-sensitive, hot melt, thermoset, and thermoplastic adhesive compositions. The vehicle can include any pressure-sensitive adhesive composition including solvent-coatable, hot-melt-coatable, radiation-curable (e.g., with E-beam, actinic radiation such as visible and UV, and thermal), water-based adhesives (e.g., emulsions) and combinations thereof. Pressure-sensitive adhesive (PSA) compositions suitable for the vehicle include tackified rubber adhesives (e.g., natural rubber, olefins, silicones, polyisoprenes, polybutadiene, polyurethanes, styrene-isoprene-styrene and styrene-butadiene-styrene block copolymers and other elastomers), and tackified and untackified acrylic adhesive compositions. In some embodiments, the PSA composition is not and/or does not comprise a silicone rubber.

In some embodiments, the vehicle comprises at least one of an organic polymer or an organic monomer. In some embodiments, the vehicle comprises an organic polymer and an organic monomer used to make the organic polymer.

In some embodiments, the vehicle comprises an acrylic PSA or precursor thereof (e.g., first and optionally second acrylic monomers). In some embodiments, the vehicle comprises a copolymer of an alkyl ester of acrylic acid as a first monomer and, optionally, a minor portion of a second monomer. Useful acrylic acid esters include acrylic or methacrylic acid esters of a monohydric alcohol having from 1 to 20 carbon atoms. Suitable acrylic or methacrylic acid esters of a monohydric alcohol include those represented by Formula V:

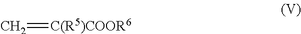

wherein R⁵ is hydrogen or a methyl group and R⁶ is an alkyl group having 4 to 20, 4 to 18, 4 to 16, 4 to 12, 6 to 12, or 8 to 12 carbon atoms, which may be linear, branched, cyclic, or polycyclic. Examples of suitable monomers represented by Formula V include n-butyl acrylate, s-butyl acrylate, t-butyl acrylate, n-pentyl acrylate, isopentyl acrylate, hexyl acrylate, cyclohexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, lauryl acrylate, stearyl acrylate, isostearyl acrylate, isobornyl acrylate, 2-methylbutyl acrylate, 4-methyl-2-pentyl acrylate, octadecyl acrylate, 2-propylheptyl acrylate, methacrylates of the foregoing acrylates, and combinations thereof. Further examples of suitable monomers for a vehicle include mixtures of at least two or at least three structural isomers of a secondary alkyl (meth)acrylate of Formula (VI):

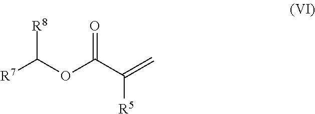

wherein R⁷ and R⁸ are each independently a C₁ to C₃₀ saturated linear alkyl group; the sum of the number of carbons in R⁷ and R⁸ is 7 to 31; and R⁵ is hydrogen or a methyl group. The sum of the number of carbons in R⁷ and R⁸ can be, in some embodiments, 7 to 27, 7 to 25, 7 to 21, 7 to 17, 7 to 11, or 7. Methods for making and using such monomers and monomer mixtures are described in U.S. Pat. No. 9,102,774 (Clapper et al.).

Second monomer units can be more polar than the first monomer units. Examples of suitable second monomers useful for preparing acrylic PSAs include an acrylic acid (e.g., acrylic acid, methacrylic acid, itaconic acid, maleic acid, and fumaric acid), an acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a hydroxyl- or amino-substituted acrylate (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl pyrrolidone, N-vinyl caprolactam, an alpha-olefin, a vinyl ether, a vinyl ester (vinyl acetate, vinyl benzoate, vinyl 4-tert-butylbenzoate, vinyl cinnamate, vinyl decanoate, vinyl neodecanoate, vinyl neononanoate, vinyl pivalate, vinyl propionate, vinyl stearate, and vinyl valerate), an allyl ether, a styrenic monomer (e.g., 4-tert-butoxystyrene, 4-(tert-butyl)styrene, 4-chloromethylstyrene, chloromethylstyrene, 3-chlorostyrene, 2 (diethylamino)ethylstyrene, 2-methylstyrene, 4-methylstyrene, 4-nitrostyrene, and 4 vinylbenzoic acid), a maleate, and combinations thereof. In some embodiments, the acrylic polymer comprises second monomer units of at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid. Other useful monomers that may be in acrylate-based adhesive compositions include ethylenically-unsaturated monomers such as methyl methacrylate, ethyl methacrylate, propyl methacrylate, and combinations thereof.

Crosslinked acrylic PSAs may be made, for example, by including one or more polyfunctional crosslinking monomers in the formulation. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Crosslinking can also be achieved without a crosslinking agent by using high energy radiation such as gamma or electron beam radiation.

Typically, the alkyl ester of acrylic acid (e.g., first monomer represented by formula V or VI) is used in an amount of 75 weight percent to 100 weight percent based on a total weight of monomers to make the acrylic polymer, and a second monomer as described above is used in an amount of 0 weight percent to 25 weight percent based on a total weight of monomers to make the acrylic polymer. In some embodiments, the first monomer is used in an amount of at least 80, 85, 90, 92, 95, 97, 98, or 99 percent by weight based on the total weight of the monomers, and the second monomer is used in an amount of up to 20, 15, 10, 8, 5, 3, 2, or 1 percent by weight based on the total weight of the monomers. These percentages also reflect the percentages of the various monomer units in the acrylic polymer. When present, the polyfunctional crosslinking monomer can be used in an amount of 0.002 to 2 parts per hundred parts of the monofunctional monomers, for example from about 0.01 to about 0.5 parts or from about 0.05 to 0.15 parts per hundred parts of the monofunctional monomers.

The vehicle can include any of these monomers, a polymer made from any of these monomers, or a combination thereof.

When the vehicle includes monomers, polymerization of the monomers can be achieved by various conventional free radical polymerization methods (e.g., solvent polymerization, emulsion polymerization, suspension polymerization, and bulk polymerization), which can be chemically, thermally, and/or radiation initiated. Polymerization can be initiated by actinic radiation (e.g., visible or ultraviolet light), electron beam radiation, and combinations thereof.

The vehicle can also include free-radical initiators such as thermal initiators and photoinitiators. Certain photoinitiators, when used, can be consumed upon reaction with light and may not be present in the foam composition of the present disclosure. In some embodiments, the foam composition further comprises a photoinitiator or a fragment thereof. Any suitable photoinitiator may be useful in the foam composition comprising at least one acrylic monomer, for example, first and second acrylic monomers as described above in any of their embodiments. Suitable photoinitiators include type I or type II photoinitiators. Suitable photoinitiators may include acetophenones, benzilketal, alkylaminoacetophenones, benzoyl phosphine oxides, benzoin ethers, benzophenones, and benzoylformate esters. In some embodiments, the free radical photoinitiator is a type I (cleavage-type) photoinitiator. Cleavage-type photoinitiators include acetophenones, alpha-aminoalkylphenones, benzoin ethers, benzoyl oximes, acyl (e.g., benzoyl) phosphine oxides, acyl (e.g., benzoyl)phosphinates, and mixtures thereof.

Examples of useful benzoin ethers include benzoin methyl ether and benzoin butyl ether.

Examples of suitable acetophenone compounds include 4-diethylaminoacetophenone, 1-hydroxycyclohexyl phenyl ketone, 2-benzyl-2 dimethylamino-4′-morpholinobutyrophenone, 2-hydroxy-2-methyl-1-phenylpropan-1 one, and 2,2-dimethoxy-1,2-diphenylethan-1-one. Example of suitable acyl phosphine oxide, acyl phosphinate, and acyl phosphonate compounds include bis(2,6-dimethoxybenzoyl)-2,4,4-trimethylpentyl phosphine oxide, phenylbis(2,4,6-trimethylbenzoyl)phosphine oxide, ethyl phenyl(2,4,6-trimethylbenzoyl)phosphinate, (2,4,6-trimethylbenzoyl)diphenylphosphine oxide, dimethyl pivaloylphosphonate, and poly(oxy-1,2-ethanediyl), α,α′,α″-1,2,3-propanetriyltris [ω-[phenyl(2,4,6-trimethylbenzoyl)phosphinyl]oxy]. Many photoinitiators are available, for example, from BASF, Vandalia, Ill. under the trade designation “IRGACURE”, from IGM Resins, Waalwijk, Netherlands, under the trade designations “OMNIRAD” and “ESACURE”. Two or more of any of these photoinitiators may also be used together in any combination. The photoinitiator may be selected, for example, based on the desired wavelength for curing and compatibility with the composition.

Examples of suitable thermal initiators include peroxides (e.g., benzoyl peroxide, dibenzoyl peroxide, dilauryl peroxide, cyclohexane peroxide, and methyl ethyl ketone peroxide), hydroperoxides (e.g., butyl hydroperoxide and cumene hydroperoxide), dicyclohexyl peroxydicarbonate, t-butyl perbenzoate, and azo compounds such as 2,2,-azo-bis(isobutyronitrile) (AIBN), and combinations thereof. Examples of commercially available thermal initiators include initiators available under the “VAZO” trade designation from The Chemours Company (Wilmington, DE) such as “VAZO 64” (2,2′-azobis(isobutyronitrile)), “VAZO 52”, “VAZO 65” and “VAZO 68” and initiators available under the “CELOGEN” trade designation from CelChem LLC, Naples, FL. Peroxides are available from a variety of sources.

An initiator is used in an amount effective to facilitate polymerization of the monomers present in the vehicle, and the amount will vary depending upon, for example, the type of initiator, the molecular weight of the initiator, the intended application of the resulting adhesive composition, and polymerization process factors such as temperature. The photoinitiator can be used in any amount effective to facilitate polymerization of the monomers (e.g., 0.1 part to about 5 parts, 0.2 part to about 2 parts, or about 0.1 part to about 1 part per hundred parts of the monofunctional monomers used to make the acrylic polymer).

In some embodiments, the vehicle includes a photoinitiator which can be considered a photocrosslinker. Examples of suitable photocrosslinkers include ethylenically unsaturated compounds which in the excited state are capable of abstracting hydrogen (e.g., acrylated benzophenones such as described in U.S. Pat. No. 4,737,559 (Kellen et al.)), p-acryloxybenzophenone, which is available from Sartomer Company, Exton, PA, monomers described in U.S. Pat. No. 5,073,611 (Rehmer et al.) including p-N-(methacryloyl-4-oxapentamethylene)-carbamoyloxybenzophenone, N-(benzoyl-p-phenylene)-N′-(methacryloxymethylene)-carbodiimide, and p-acryloxy-benzophenone), and para-acryloxyethoxybenzophenone; monofunctional benzophenones (e.g., benzophenone, 4-phenylbenzophenone, 4-methoxybenzophenone, 4,4′-dimethoxybenzophenone, 4,4′-dimethylbenzophenone, 4-methylbenzophenone, 4-(2-hydroxyethylthio)-benzophenone, and 4-(4-tolylthio)-benzophenone); polyfunctional benzophenones (e.g., di-esters of carboxymethoxy-benzophenone and polytetramethyleneglycol 250); anthraquinone photocrosslinkers (e.g., anthraquinone, 2-methyl anthraquinone, 2-t-butyl anthraquinone, 2-ethyl anthraquinone, 2-phenyl anthraquinone, 1,4-dimethyl anthraquinone, 2,3-dimethyl anthraquinone, 1,2-dimethyl anthraquinone, I-methoxy-2-methyl anthraquinone, 2-acetyl anthraquinone, and 2,6-di-t-butyl anthraquinone); thioxanthone photocrosslinkers (e.g., thioxanthone, 2-isopropylthioxanthone, 2-chlorothioxanthone, 2-dodecylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 1-ethoxycarbonyl-3-(1-methyl-1-morpholinoethyl)-thioxanthone, 2-methyl-6-dimethoxymethylthioxanthone, 2-methyl-6-(1,1-dimethoxybenzyl)-thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 6-ethoxycarbonyl-2-methoxythioxanthone; and 6-ethoxycarbonyl-2-methylthioxanthone); halomethyl-1, 3, 5-triazines (e.g., 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley); and 2,4-bis(trichloromethyl)-6-naphthenyl-s-triazine and 2,4-bis(trichloromethyl)-6-(4-methoxy) naphthenyl-s-triazine as described in U.S. Pat. No. 4,329,384 (Vesley)). The photocrosslinkers may be present in the acrylic polymer in any useful amount. For example, an amount of 0.001 to 10 parts, 0.001 to 5 parts, 0.001 to 2 parts, 0.001 to 1 part, 0.001 to 0.5 part, or 0.001 to 0.1 part per hundred parts of the monofunctional monomers may be useful in a vehicle comprising at least one acrylic monomer, for example, first and second acrylic monomers as described above in any of their embodiments.

A polymerizable vehicle composition may also include a chain transfer agent. The chain transfer agent can be selected to be soluble in a monomer mixture to be polymerized. Examples of suitable chain transfer agents include triethyl silane and mercaptans.

In some embodiments of the foam composition of the present disclosure and/or made by the method of the present disclosure, the vehicle comprises or is derived from a composition comprising at least one acrylic monomer, for example, first and second acrylic monomers as described above in any of their embodiments, and a polymer prepared from the partial polymerization of the at least one acrylic monomer. The vehicle can be a solution of polymer in the at least one monomer and can be, for example, about 3 percent to 15 percent polymerized. In some embodiments, the vehicle comprises at least 75, 80, 85, 90, or 95 percent by weight monomer(s), based on the total weight of the vehicle. In some embodiments, the vehicle is exposed to ultraviolet radiation to provide the solution of the polymer in the at least one acrylic monomer. It is also possible for the solution of the polymer in the at least one acrylic monomer to be made by partial free-radical polymerization using a thermal initiator or other free-radical source.

A useful solvent-free polymerization method is disclosed in U.S. Pat. No. 4,379,201 (Heilmann et al.). Initially, a mixture of first and second monomers can be polymerized with a portion of a photoinitiator by exposing the mixture to UV radiation in an inert environment for a time sufficient to form a coatable base syrup, and subsequently adding a crosslinking agent and the remainder of the photoinitiator. The crosslinking can be, for example, any of the polyfunctional crosslinking monomers described above in any of the amounts described above. This final syrup containing a crosslinking agent (e.g., which may have a Brookfield viscosity of about 500 centipoise (cps) to about 10,000 cps at 23° C., about 100 cps to about 6000 cps at 23° C., or about 5,000 cps to about 7,500 cps at 23° C. as measured with a No. 4 LTV spindle, at 60 revolutions per minute) can then be coated onto a substrate. Once the syrup is coated onto the substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated PET film, that is transparent to UV radiation or e-beam irradiation.

Any suitable light source may be used, including fluorescent UV bulbs, mercury lamp (e.g., a low-pressure mercury lamp, a medium-pressure mercury lamp, a high-pressure mercury lamp, an ultrahigh-pressure mercury lamp), a xenon lamp, a metal halide lamp, an electrodeless lamp, an incandescent lamp, LEDs, and lasers. For broadband light sources (e.g., a fluorescent UV bulb, mercury lamp, or incandescent lamp), filters may be useful for narrowing the wavelength ranges to be within or outside the wavelength at which the ultraviolet light absorber absorbs and/or to modify the intensity of the light source.

The vehicle and/or foam composition can also include other ingredients such as curing agents, cure accelerators, catalysts, tackifiers, plasticizers, dyes, flame retardants, adhesion promoters (e.g., coupling agents such as silane coupling agents), pigments, impact modifiers, flow control agents, foaming agents, fillers (e.g., talc, zinc oxide, and fused silica), glass and polymer microspheres and microparticles, electrically conductive particles, thermally conductive particles, fibers, antistatic agents, antioxidants such as hindered phenols, amines, and sulfur and phosphorous hydroperoxide decomposers, UV absorbers, stabilizers (e.g., hindered amine light stabilizers and heat stabilizers); and viscosity adjusting agents such as fumed silica.

Foam compositions of the present disclosure and/or made by the processes of the present disclosure can include hollow microspheres (e.g., hollow ceramic (e.g., glass) microspheres or hollow polymeric microspheres such as elastomeric particles available, for example, from Akzo Nobel, Amsterdam, The Netherlands, under the trade designation “EXPANCEL”. Examples of hollow ceramic microspheres include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”), calcium carbonate-coated polyvinylidene copolymer microspheres having a specific gravity of 0.13 (“DUALITE 6001AE”, Pierce & Stevens Corp.), and glass bubbles marketed by 3M Company, Saint Paul, Minnesota, as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”. Foams that include hollow microspheres are referred to as syntactic foams. Foamed adhesives can also include a hydrocarbon elastomer as described in U.S. Pat. No. 5,024,880 (Vesley et al.).

In some embodiments, the vehicle that comprises an adhesive composition comprises a tackifier, useful for increasing the stickiness of the surface of a PSA. In some embodiments, the foam composition does not comprise a tackifier. Useful tackifiers can have a number average molecular weight of up to 10,000 grams per mole, a softening point of at least 70° C. as determined using a ring and ball apparatus, and a glass transition temperature of at least −30° C. as measured by differential scanning calorimetry. Useful tackifiers are typically amorphous. In some embodiments, the tackifier is miscible with the polymer(s) of the PSA such that macroscopic phase separation does not occur in the PSA. In some embodiments, the PSA is free of microscopic phase separation as well. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. Any of these tackifying resins may be hydrogenated (e.g., partially or completely). Examples suitable tackifiers include those obtained under the trade designations “FLORAL” including “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ” including “ESCOREZ 2520” and “ESCOREZ 5615” (aliphatic/aromatic hydrocarbon resins) commercially available from ExxonMobil Corp., Houston, TX; “ARKON” such as “ARKON P125” a fully hydrogenated hydrocarbon resin, commercially available from Arakawa Chemical Inc., Chicago, Illinois, and “REGALITE” such as “REGALITE 7100” (a partially hydrogenated hydrocarbon resin) commercially available from Eastman, Kingsport, Tennessee.

In some embodiments, the vehicle includes at least about one percent by weight and up to about 50 percent by weight of the tackifier, based on the total weight of the vehicle. In some embodiments, the tackifier is present in a range from 1 to 25, 2 to 20, 2 to 15, 1 to 10, or 3 to 10 percent by weight, based on the total weight of the vehicle.

Plasticizers may be added, e.g., to reduce vitrification of an adhesive composition. Suitable plasticizers include various polyalkylene oxides (e.g., polyethylene oxides or propylene oxides), adipic acid esters, formic acid esters, phosphoric acid esters, benzoic acid esters, phthalic acid esters, polyisobutylenes, polyolefins, and sulfonamides, naphthenic oils, plasticizing aids such as those materials described as plasticizers in the Dictionary of Rubber, K. F. Heinisch, pp. 359, John Wiley & Sons, New York (1974), oils, elastomer oligomers, and waxes. The amount of plasticizer employed, if one is employed, will depend on the nature of the plasticizer and its compatibility with the vehicle.

In some embodiments, the foam composition of the present disclosure and/or made by the processes of the present disclosure is substantially solvent free. Common organic solvents include aliphatic and alicyclic hydrocarbons (e.g., hexane, heptane, and cyclohexane), hydrocarbon solvents (e.g., benzene, toluene, xylenes, and d-limonene); acyclic and cyclic ketones (e.g., acetone, methyl ethyl ketone, and methyl isobutyl ketone, pentanone, hexanone, cyclopentanone, and cyclohexanone); ethers (e.g., diethyl ether, glyme, diglyme, diisopropyl ether, and tetrahydrofuran), esters (e.g., ethyl acetate and butyl acetate), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and alcoholic solvents (e.g., methanol, ethanol, or propanol such as isopropanol). The foam composition can be substantially free of any of these solvents. The term “substantially free” means that the foam composition can include up to 0.5, 0.1, 0.05, or 0.01 percent by weight of any of these solvents or can be free of any of these solvents. These percentages are based on the total weight of the foam composition.

In some embodiments, the vehicle includes a silane coupling agent. Examples of useful silane coupling agents include many of the silanes listed above useful for treating nanoparticles as well as epoxysilanes such as 2-(3,4-epoxycyclohexyl)ethyl trimethoxysilane, 3-glycidoxypropyl methyldimethoxysilane, 3-glycidoxypropyltrimethoxysilane, 3-glycidoxypropylmethoxydimethoxysilane and 3-glycidoxypropyltriethoxysilane; and aminosilanes such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane and 3-aminopropyltriethoxysilane. The silane coupling agent can be used at a quantity of approximately 0.05 weight percent or higher or approximately 0.1 weight percent or higher and approximately 2 weight percent or lower or approximately 1 weight percent or lower relative to the total weight of the vehicle.

In some embodiments, the foam composition of the present disclosure and/or made by a process of the present disclosure further comprises a foaming agent. Useful foaming agents include physical foaming agents and chemical foaming agents, either of which may be inorganic foaming agents or organic foaming agents. Useful chemical foaming mechanisms include producing gas in situ through a chemical reaction; decomposition of a component of a composition, for example, a component that liberates gas upon thermal decomposition; evaporating a component of the composition, for example, a liquid gas; volatilizing a gas in the composition by decreasing the pressure on the composition or heating the composition; and combinations thereof.

Examples of chemical foaming agents include water and azo-, carbonate- and hydrazide-based molecules including, for example, 4,4′-oxybis(benzenesulfonyl) hydrazide, 4,4′-oxybenzenesulfonyl semicarbazide, azodicarbonamide, p-toluenesulfonyl semicarbazide, barium azodicarboxylate, azodiisobutyronitrile, benzenesulfonhydrazide, trihydrazinotriazine, metal salts of azodicarboxylic acids, oxalic acid hydrazide, hydrazocarboxylates, diphenyloxide-4,4′-disulphohydrazide, tetrazole compounds, sodium bicarbonate, ammonium bicarbonate, preparations of carbonate compounds and polycarbonic acids, and mixtures of citric acid and sodium bicarbonate, N,N′-dimethyl-N,N′-dinitroso-terephthalamide, N,N′-dinitrosopentamethylenetetramine, and combinations thereof. Water is a foaming agent useful for making a polyurethane foam. Water reacts with isocyanates to ultimately form carbon dioxide, which foams the polyurethane.

Suitable inorganic physical foaming agents include, for example, nitrogen, argon, oxygen, water, air, helium, sulfur hexafluoride, and combinations thereof.

Useful organic physical foaming agents include carbon dioxide, aliphatic hydrocarbons, aliphatic alcohols, fully and partially halogenated aliphatic hydrocarbons including, for example, methylene chloride, and combinations thereof. Examples of suitable aliphatic hydrocarbon foaming agents include members of the alkane series of hydrocarbons including, for example, methane, ethane, propane, n-butane, isobutane, n-pentane, isopentane and blends thereof. Useful aliphatic alcohols include, for example, methanol, ethanol, n-propanol, and isopropanol and combinations thereof. Suitable fully and partially halogenated aliphatic hydrocarbons include, for example, fluorocarbons, chlorocarbons, and chlorofluorocarbons and combinations thereof.

Examples of suitable halogenated (in some embodiments, fluorinated) foaming agents include methyl fluoride, perfluoromethane, ethyl fluoride, 1,1-difluoroethane (HFC-152a), fluoroethane (HFC-161), 1,1,1-trifluoroethane (HFC-143a), 1,1,1,2-tetrafluoroethane (HFC-134a), 1,1,2,2 tetrafluoroethane (HFC-134), 1,1,1,3,3-pentafluoropropane, pentafluoroethane (HFC-125), difluoromethane (HFC-32), perfluoroethane, 2,2-difluoropropane, 1,1,1-trifluoropropane, perfluoropropane, dichloropropane, difluoropropane, perfluorobutane, perfluorocyclobutane, methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123) and 1-chloro-1,2,2,2-tetrafluoroethane (HCFC-124), trichloromonofluoromethane (CFC-11), dichlorodifluoromethane (CFC-12), trichloro-trifluoroethane (CFC-113), dichlorotetrafluoroethane (CFC-114), chloroheptafluoropropane, and dichlorohexafluoropropane and combinations thereof. In some embodiments, the foaming agent is not halogenated. In some embodiments, the foaming agent is not fluorinated.

The foaming agents may be used as single components, in mixtures and combinations thereof, as well as in mixtures with other co-foaming agents. A foaming agent can be added to a composition in an amount sufficient to achieve a desired foam density.

In some embodiments, the foam composition of the present disclosure and/or made by a process of the present disclosure further comprises a nucleating agent. A nucleating agent can be any conventional nucleating agent. The amount of nucleating agent to be added may be selected depending upon the desired cell size, the selected foaming agent, and the density of the vehicle. Examples of inorganic nucleating agents in small particulate form include clay, talc, silica, and diatomaceous earth.

Organic nucleating agents can decompose or react at a given temperature. One example of an organic nucleating agent is a combination of an alkali metal salt of a polycarboxylic acid with a carbonate or bicarbonate. Examples of useful alkali metal salts of a polycarboxylic acid include the monosodium salt of 2,3-dihydroxy-butanedioic acid (that is, sodium hydrogen tartrate), the monopotassium salt of butanedioic acid (that is, potassium hydrogen succinate), the trisodium and tripotassium salts of 2-hydroxy-1,2,3-propanetricarboxylic acid (that is, sodium and potassium citrate, respectively), and the disodium salt of ethanedioic acid (that is, sodium oxalate) and polycarboxylic acid such as 2-hydroxy-1,2,3-propanetricarboxylic acid, and combinations thereof. Examples of carbonates and bicarbonates include sodium carbonate, sodium bicarbonate, potassium bicarbonate, potassium carbonate, calcium carbonate, and combinations thereof. One contemplated combination is a monoalkali metal salt of a polycarboxylic acid, such as monosodium citrate or monosodium tartrate, with a carbonate or bicarbonate. It is contemplated that mixtures of different nucleating agents may be added to the vehicle. Other useful nucleating agents include a stoichiometric mixture of citric acid and sodium bicarbonate.

In some embodiments, the foam composition of the present disclosure has a foam half-life at 22° C. of at least 5 minutes, 10 minutes, 15 minutes, 20 minutes, 30 minutes, 45 minutes, or 60 minutes. In this application, the foam half-life is determined by placing about 30 grams of a one weight percent solution of a blend of surface-modified nanoparticles and at least one of the silicone MQ resin or the poly(alkyleneoxide)-modified polydimethylsiloxane in a vehicle in 4-ounce glass jar and bubbling nitrogen through the mixture at 22° C. for five minutes while stirring the mixture with a magnetic stir bar set at a low setting using the apparatus described in the Syrup Bubbling Test in the Examples. The bubbling is stopped, and the magnetic stir bar is turned off. The foam height is measured with a ruler. The time necessary for half of the liquid to be drained from the foam (i.e., to provide half of the initial volume of liquid) is measured to provide the foam half-life.

As shown in a comparison of Examples 1 to 6 and Comparative Example 1 in the Examples below, silicone MQ resins, which are reported to be defoamers or anti-foamers are not detrimental to the foaming capability of surface-modified nanoparticles in a vehicle of acrylic monomers. In fact, the silicone MQ resins are shown to enhance the foaming capability of the surface-modified nanoparticles in Examples 1 to 3. Also, silicone MQ resins were found to be compatible with surface-modified nanoparticles, causing no gelation or inhomogeneities when mixed together. As shown in a comparison of Examples 7, 8, and to 10 and Comparative Examples 2 and 4 in the Examples below, compositions that include surface-modified nanoparticles and a poly(alkyleneoxide)-modified polydimethylsiloxane are surprisingly synergistic, with the combination more capable of foaming and forming a persistent foam than compositions that include either the surface-modified nanoparticles or the poly(alkyleneoxide)-modified polydimethylsiloxane alone. Examples 7 and 8 foamed better and formed a more persistent foam than Example 9. In addition to having a number average molecular weight of not more than 10,000 grams per mole, the poly(alkyleneoxide)-modified polydimethylsiloxane used for Examples 7 and 8 included ethyleneoxy groups while the poly(alkyleneoxide)-modified polydimethylsiloxane used for Example 9 included a combination of ethyleneoxy groups and propyleneoxy groups.

The present disclosure provides a process for making the foam composition of the present disclosure as described above in any of its embodiments. The process comprises introducing a foaming agent into a composition comprising the vehicle, the surface-modified nanoparticles having a particle diameter of not more than 100 nanometers, and at least one of the silicone MQ resin or the poly(alkyleneoxide)-modified polydimethylsiloxane to form voids in the composition. The foaming agent can be any of the chemical or physical foaming agents described above. In some embodiments, the composition is foamed after the surface-modified nanoparticles have become dispersed throughout the vehicle, in some embodiments, homogeneously dispersed throughout the vehicle. The composition can be foamed according to a variety of foaming methods including those described in, for example, U.S. Pat. No. 5,024,880 (Vesley et al.), 4,895,745 (Vesley et al.) and 4,748,061 (Vesley et al.).

The composition can be foamed by forming gas voids in the composition using a variety of mechanisms including mechanical mechanisms, chemical mechanisms, and combinations thereof. Useful mechanical foaming mechanisms include agitating (e.g., shaking, stirring, and/or whipping the composition), injecting gas into the composition, for example, inserting a nozzle beneath the surface of the composition and blowing gas into the composition, and combinations thereof. In some embodiments, introducing of the foaming agent comprises at least one of stirring the composition or injecting gas into the composition. In some embodiments, the foaming agent comprises at least one of air, nitrogen, oxygen, carbon dioxide, helium, argon, or nitrous oxide.

The foam composition of the present disclosure and/or made by a process of the present disclosure is suitable for use in a variety of applications. Representative examples of foam applications include adhesives, flotation, applications in the automotive industry including automotive body moldings, applications related to automotive glazing including gaskets and sealants, applications in the construction industry including structural components (e.g., sized lumber, shaped trim, posts, beams, and shaped structural members), lightweight ceramics including pre-cast and cast-in-place construction materials including cementitious and gypsum materials such as blocks, boards, panels, roofdecks, and flooring, landfill covers, odor barriers, dust covers, firefighting and fireproofing foams, liquid containment booms (for example, oil spill containment boom), and fillers for voids such as oil wells and tunnels and voids present in soil. Other foam applications include packaging, commercial cleaning products including cleaners for vertical cleaning applications, inks, de-inking compositions, surface coatings including, for example, foamed coatings for paper and textile treatment.

The foam compositions can also be formulated for use in applications such as foamed personal care products including, for example, hair treatment compositions, shaving compositions and skin treatment compositions; medical applications including bandages and wound dressings; and household and industrial applications including cups, plates, earplugs, cushions, pillows, insulation, a damper, for example, for suppressing sound, absorbing vibration (e.g., cushioning the vibration of machine covers), and combinations thereof, and baffles.

In another embodiment, the foam composition is formulated to be useful as a gasket or seal to seal an area from, for example, dust, moisture, organic vapor, and combinations thereof. Examples of sealing applications include sealing gaps between parts in computer printers, sealing electronic equipment, and sealing skylight assemblies.

The foam composition can be formulated to provide foams that are flexible and conformable and suitable for filling gaps and bonding irregular surfaces. The foam can also be formulated to provide a bond line that seals, cushions vibration, damps vibration, resists impact, withstands a wide temperature range or provides good insulating qualities or provides a combination of these properties.

The foam composition can be in the form of a tape such as a pressure-sensitive adhesive tape. Useful foam tape constructions include a foam composition disposed on a substrate, for example, a backing or a release liner, and, optionally, wound in the form of a roll. In some embodiments, the foam tape construction includes an adhesive composition disposed on a surface of a foam tape, which forms a tape having an adhesive layer on one side of the foam tape, that is, a single coated adhesive foam tape. In another embodiment, the foam composition can be in the form of a tape having an adhesive layer on two major surfaces of the foam tape, which is known as double-coated foam tape.

The present disclosure provides a process for making an adhesive tape, the process comprising applying the foam composition to a substrate. Applying the foam composition to a substrate can be carried out after it is foamed using any of the methods described above, that is, after voids are formed therein. The foam composition can be applied to the substrate using a variety of methods (e.g., dipping, spraying, brushing, roll coating, bar coating). In some embodiments, the composition can be coated on a liner with a notch bar with a gap setting to provide the desired thickness above the liner, and another liner may be added to maintain a gap of the desired thickness. Although any of the foam compositions described above in any of their embodiments can be applied to a substrate, in some embodiments, the vehicle comprises a monomer and optionally a polymer, and the process further comprises polymerizing the monomer. In some embodiments, the process further comprises crosslinking the foam composition. When polymerizing or crosslinking using a UV light source such as any of those described above is used, any useful amount of UV irradiation can be employed, such as from approximately 1,000 mJ/cm² to approximately 10,000 mJ/cm², 1,000 mJ/cm² to approximately 5,000 mJ/cm², or from approximately 1,000 mJ/cm² to approximately 3,000 mJ/cm².

Adhesive foams have a variety of useful applications including, for example, bonding two substrates together, mounting applications using articles including hooks, hangers, and holders, joining applications including adhering two or more containers, for example, boxes, together for later separation, bonding articles to surfaces, for example, walls, floors, ceilings and counters and replacing mechanical fasteners, mastics, or liquid glues. When bonding rough or irregular surfaces, the properties and formulation of the foam tape may be selected to provide a foam tape that distributes stress uniformly over the bonded area. Other adhesive foam applications include, for example, as structural adhesives and foam-in-place adhesives.

In other embodiments, the foam composition includes other components such as scrims, films, tissues, and combinations thereof, dispersed in the foam or disposed in a layered construction with the foam composition in the form of, for example, alternating layers, interpenetrating layers, and combinations thereof. Other useful foam constructions include multi-layer foam constructions that include layers of foam where the layers differ in at least one property including, for example, density and composition.

The foam composition can also be subjected to post processes including, for example, die cutting, crosslinking, and sterilization.

### Some Embodiments of the Disclosure

In a first embodiment the present disclosure provides a foam composition comprising: a vehicle, surface-modified nanoparticles having a particle diameter of not more than 100 nanometers, and at least one of a silicone MQ resin or a poly(alkyleneoxide)-modified polydimethylsiloxane. In a second embodiment the present disclosure provides the foam composition of the first embodiment, wherein the foam composition comprises the silicone MQ resin. In a third embodiment, the present disclosure provides a foam composition comprising: a vehicle, surface-modified nanoparticles having a particle diameter of not more than 100 nanometers, and a silicone MQ resin. In a fourth embodiment the present disclosure provides the foam composition of any one of the first to third embodiments, wherein the silicone MQ resin has an M:Q ratio of at least 0.8:1, 0.9:1, 1:1, 1.1:1, or 1.2:1. In a fifth embodiment the present disclosure provides the foam composition of any one of the first to fourth embodiments, wherein the silicone MQ resin has an M:Q ratio of not more then 2.5:1 or 2:1. In a sixth embodiment, the present disclosure provides the foam composition of any one of the first to fifth embodiments, wherein the silicone MQ resin is prepared by a reaction of a one or more compounds represented by formula (R)₃—Si—R¹ and one or more compounds represented by formula (R¹)₄Si, wherein each R is independently hydrogen, alkyl, aryl, alkylene at least one of interrupted or terminated by arylene or heterocyclylene, wherein alkyl and alkylene at least one of interrupted or terminated by arylene or heterocyclylene are unsubstituted or substituted with halogen and optionally interrupted by at least one catenated —O—, —NR′—, —S—, —Si—, or combination thereof, and wherein aryl, arylene, and heterocyclylene are unsubstituted or substituted by at least one alkyl, alkoxy, halogen, or combination thereof, and wherein each R¹ is independently a hydrolyzable group. R may be other than hydrogen. R may be free of alkyleneoxy groups such as —(OR²)ₙ—OR³ groups, in which n, R², and R³ are as defined below in any of their embodiments. In a seventh embodiment, the present disclosure provides the foam composition of any one of the first to sixth embodiments, wherein the silicone MQ resin comprises methyl groups. In an eighth embodiment, the present disclosure provides the foam composition of any one of the first to seventh embodiments, wherein the silicone MQ resin has a hydroxyl content in a range from 185 to 1840 milliequivalents per kilogram. In a ninth embodiment, the present disclosure provides the foam composition of any one of the first to eighth embodiments, wherein the foam composition comprises or further comprises the poly(alkyleneoxide)-modified polydimethylsiloxane. In a tenth embodiment, the present disclosure provides the foam composition of the first or ninth embodiment, wherein the poly(alkyleneoxide)-modified polydimethylsiloxane comprises repeating divalent units represented by formula II:

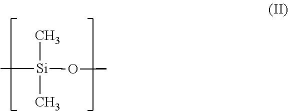

and at least one of terminal units represented by formula -Q-(OR²)ₙ—OR³ or divalent units represented by formula III:

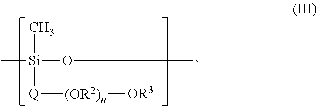

wherein each Q is independently alkylene, arylene, or alkylene that is at least one of interrupted or terminated by aryl, each of which is optionally at least one of interrupted or terminated by at least one ether, thioether, amine, amide, ester, thioester, carbonate, thiocarbonate, carbamate, thiocarbamate, urea, or thiourea, each OR² is independently —OCH₂CH₂—, —OCH(CH₃) CH₂—, —OCH₂CH₂CH₂—, —OCH₂CH(CH₃)—, —OCH₂CH₂CH₂CH₂—, —OCH(CH₂CH₃) CH₂—, —OCH₂CH(CH₂CH₃)—, and —OC(CH₃)₂CH₂—, each n is independently a value from 5 to 300, and each R³ is hydrogen, alkyl, acyl, aryl, or arylalkylenyl, wherein aryl and arylalkylenyl are unsubstituted or substituted by at least one alkyl, alkoxy, or combination thereof. In an eleventh embodiment, the present disclosure provides the foam composition of the first, ninth, or tenth embodiment, wherein the poly(alkyleneoxide)-modified polydimethylsiloxane has a number average molecular weight of not more than 50,000 grams per mole, 40,000 grams per mole, 30,000 grams per mole, 20,000 grams per mole, or 10,000 grams per mole. In a twelfth embodiment, the present disclosure provides the foam composition of any one of the first or ninth to eleventh embodiments, wherein the poly(alkyleneoxide)-modified polydimethylsiloxane comprises ethyleneoxy groups, proyleneoxy groups, or a combination thereof. In a thirteenth embodiment, the present disclosure provides the foam composition of any one of the first to twelfth embodiments, wherein the silicone MQ resin, the poly(alkyleneoxide)-modified polydimethylsiloxane, or a combination thereof is present in the foam composition in an amount from 0.1 weight percent to 10 weight percent, 0.1 weight percent to 5 weight percent, or 0.5 weight percent to 5 weight percent based on the total weight of the foam composition.

In a fourteenth embodiment, the present disclosure provides the foam composition of any one of the first to twelfth embodiments, wherein the vehicle comprises at least one of a monomer or a polymer or a combination thereof. In a fifteenth embodiment, the present disclosure provides the foam composition of any one of the first to fourteenth embodiments, wherein the vehicle is not a silicone or a silicone-containing polymer. In a sixteenth embodiment, the present disclosure provides the foam composition of any one of the first to fifteenth embodiments, wherein the vehicle comprises at least one of a thermoplastic polymer, a thermoset polymer, or an elastomer. In a seventeenth embodiment, the present disclosure provides the foam composition of any one of the first to sixteenth embodiments, wherein the vehicle comprises at least one of a polyester, a polyurethane, an amino resin, an alkyd resin, a phenolic resin, an epoxy resin, an isocyanate resin, an isocyanurate resin, or an acrylic polymer. In an eighteenth embodiment, the present disclosure provides the foam composition of any one of the first to seventeenth embodiments, wherein the vehicle comprises a crosslinked polymer. In a nineteenth embodiment, the present disclosure provides the foam composition of any one of the first to eighteenth embodiments, wherein the vehicle comprises at least one of an acrylate or an acrylic polymer. In a twentieth embodiment, the present disclosure provides the foam composition of any one of the first to nineteenth embodiments, wherein the vehicle comprises at least one of isooctyl acrylate, 2-ethylhexyl acrylate, 2-propylheptyl acrylate, butyl acrylate, acrylic acid, or mixtures of at least two or at least three structural isomers of a secondary alkyl (meth)acrylate of Formula (VI):

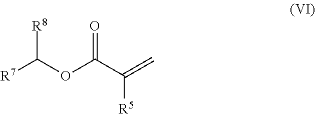

wherein R⁷ and R⁸ are each independently a C₁ to C₃₀ saturated linear alkyl group; the sum of the number of carbons in R⁷ and R⁸ is 7 to 31; and R³ is hydrogen or a methyl group, or a polymer comprising units of any of these. In a twenty-first embodiment, the present disclosure provides the foam composition of any one of the first to twentieth embodiments, wherein the vehicle comprises acrylic acid and at least one of isooctyl acrylate or 2-ethylhexyl acrylate. In a twenty-second embodiment, the present disclosure provides the foam composition of any one of the first to twenty-first embodiments, wherein said vehicle comprises polyolefin. In a twenty-third embodiment, the present disclosure provides the foam composition of any one of the first to twenty-second embodiments, wherein the vehicle comprises at least one of a novolac resin, a resole resin, or a polyurea resin. In a twenty-fourth embodiment, the present disclosure provides the foam composition of any one of the first to twenty-third embodiments, wherein the vehicle comprises at least one of an isocyanate, a polyurethane, or a polyurea. In a twenty-fifth embodiment, the present disclosure provides the foam composition of any one of the first to twenty-fourth embodiments, wherein the vehicle comprises at least one of an alcohol, an aldehyde, a ketone, an ester, an ether, an amine, an amide, or a hydrocarbons.

In a twenty-sixth embodiment, the present disclosure provides the foam composition of any one of the first to twenty-fifth embodiments, wherein the vehicle has voids therein. In a twenty-seventh embodiment, the present disclosure provides the foam composition of any one of the first to twenty-sixth embodiments, further comprising a foaming agent. In a twenty-eighth embodiment, the present disclosure provides the foam composition of the twenty-seventh embodiment, wherein the foaming agent comprises at least one of air, nitrogen, oxygen, carbon dioxide, helium, argon, or nitrous oxide. In a twenty-ninth embodiment, the present disclosure provides the foam composition of any one of the first to twenty-eighth embodiments, having a foam half-life at 22° C. of at least 10 minutes. In a thirtieth embodiment, the present disclosure provides the foam composition of any one of the first to twenty-ninth embodiments, further comprising at least one of fumed silica, hollow ceramic microspheres, or hollow polymeric microspheres.

In a thirty-first embodiment, the present disclosure provides the foam composition of any one of the first to thirtieth embodiments, wherein the surface-modified nanoparticles have a particle diameter of not more than about 50 nanometers. In a thirty-second embodiment, the present disclosure provides the foam composition of any one of the first to thirty-first embodiments, wherein the surface-modified nanoparticles comprise inorganic nanoparticles. In a thirty-third embodiment, the present disclosure provides the foam composition of the thirty-second embodiment, wherein the surface-modified nanoparticles comprise at least one of silica, titania, alumina, zirconia, vanadia, ceria, iron oxide, antimony oxide, tin oxide, or aluminum/silica. In a thirty-fourth embodiment, the present disclosure provides the foam composition of any one of the first to thirty-first embodiments, wherein the surface-modified nanoparticles comprise organic nanoparticles. In a thirty-fifth embodiment, the present disclosure provides the foam composition of the thirty-fourth embodiment, wherein the surface-modified nanoparticles comprise at least one of alkylated buckminsterfullerenes or alklylated polyamidoamine dendrimers. In a thirty-sixth embodiment, the present disclosure provides the foam composition of any one of the first to thirty-fifth embodiments, wherein the surface-modified nanoparticles comprise hydrophobic surface groups, hydrophilic surface groups, or a combination thereof. In a thirty-seventh embodiment, the present disclosure provides the foam composition of any one of the first to thirty-sixth embodiments, wherein the surface-modified nanoparticles comprise surface groups derived from an organosilane, organic acid, organic base, or a combination thereof. In a thirty-eighth embodiment, the present disclosure provides the foam composition of any one of the first to thirty-seventh embodiments, wherein the surface-modified nanoparticles comprise surface groups derived from an organosilane, a carboxylic acid, a sulfonic acid, a phosphonic acid, or a combination thereof. In a thirty-ninth embodiment, the present disclosure provides the foam composition of any one of the first to thirty-eighth embodiments, wherein the surface-modified nanoparticles are present in the foam composition in an amount from 0.1 weight percent to 10 weight percent, 0.1 weight percent to 5 weight percent, or 0.5 weight percent to 3 weight percent based on the total weight of the foam composition. In a fortieth embodiment, the present disclosure provides the foam composition of any one of the first to thirty-ninth embodiments, wherein the foam composition is free of fluorinated surfactant.

In a forty-first embodiment, the present disclosure provides the foam composition of any one of the first to fortieth embodiments, wherein the vehicle comprises an adhesive composition. In a forty-second embodiment, the present disclosure provides the foam composition of the forty-first embodiment, wherein the vehicle comprises a pressure-sensitive adhesive composition. In a forty-third embodiment, the present disclosure provides the foam composition of the forty-first embodiment, wherein the vehicle comprises a hot melt adhesive composition. In a forty-fourth embodiment, the present disclosure provides an adhesive tape comprising the foam composition of any one of the forty-first to forty-third embodiments. In a forty-fifth embodiment, the present disclosure provides an article comprising the foam composition of any one of the first to forty-third embodiments.

In a forty-sixth embodiment, the present disclosure provides a process for making the adhesive tape of the of the forty-fourth embodiment, the process comprising applying the foam composition to a substrate. In a forty-seventh embodiment, the present disclosure provides the process of the forty-sixth embodiment, wherein the vehicle comprises a monomer and optionally a polymer, the process further comprising polymerizing the monomer. In a forty-eighth embodiment, the present disclosure provides the process of the forty-sixth or forty-seventh embodiment, further comprising crosslinking the foam composition. In a forty-ninth embodiment, the present disclosure provides a process for making the foam composition of any one of the first to forty-third embodiments, the process comprising introducing a foaming agent into a composition comprising the vehicle, the surface-modified nanoparticles having a particle diameter of not more than 100 nanometers, and at least one of the silicone MQ resin or the poly(alkyleneoxide)-modified polydimethylsiloxane to form voids in the composition. In a fiftieth embodiment, the present disclosure provides the process of the forty-ninth embodiment, wherein the introducing of the foaming agent comprises at least one of stirring the composition or injecting gas into the composition. In a fifty-first embodiment, the present disclosure provides the process of the fiftieth embodiment, wherein the foaming agent comprises at least one of air, nitrogen, oxygen, carbon dioxide, helium, argon, or nitrous oxide.

The following specific, but non-limiting, examples will serve to illustrate the present disclosure.

### EXAMPLES

Unless otherwise noted, all parts, percentages, ratios, etc. in the Examples and the rest of the specification are by weight. The following abbreviations are used in this section: g=gram, cm=centimeter, Ga=gage, LPM=liters per minute, mM=millimolar, mm=millimeter, mL=milliliters, NMR=Nuclear Magnetic Resonance, and wt %=weight percent. Materials used in the examples and their sources are shown in Table 1, below.

TABLE 1
Materials List

| Material | Description and Source |
|---|---|
| 2-EHA | 2-ethylhexyl acrylate, obtained from BASF |
| | Corporation, Florham Park, NJ |
| AA | Acrylic acid, obtained from BASF Corporation |
| OMNIRAD 651 | 2,2-Dimethoxy-2-phenylacetophenone, obtained |
| | under the trade designation “OMNIRAD |
| | 651” from IGM Resins USA Inc., Charlotte, NC |
| SILMER Q25 | Silicone MQ resin, obtained under the trade |
| | designation “SILMER Q25”, from Siltech, |
| | Toronto, Ontario, Canada |
| SILMER Q20 | Silicone MQ resin, obtained under the trade |
| | designation “SILMER Q20”, from Siltech |
| SQO-299 | Silicone MQ resin, obtained under the trade |
| | designation “SQO-299”, from Gelest, |
| | Morrisville, PA |
| EFKA SL 3299 | Organosilicone, obtained under the trade |
| | designation “EFKA SL 3299”, from BASF |
| EFKA SL 3030 | Organosilicone, obtained under the trade |
| | designation “EFKA SL 3030”, from BASF |
| SILWET L77 | Organosilicone - trisiloxane ethoxylate, obtained |
| | under the trade designation “SILWET L77”, |
| | from Momentive, Friendly, WV |
| NALCO 2326 | aqueous colloidal silica dispersion obtained under |
| | the trade designation “NALCO 2326 from Nalco, |
| | Napierville, IL |
| n-octyltrimethoxy | n-octyltrimethoxy silane obtained under the trade |
| silane | designation “OCTMO” from Evonik, Parsippany, NJ |
| methyltrimeth- | Methyltrimethoxysilane obtained under the trade |
| oxysilane | designation “SILAN M1” from Wacker Chemie, |
| | Munich, Germany |
| phenothiazine | Phenothiazine obtained from Solvay/Cytec, Woodland |
| | Park, NJ |

### M:Q Ratio Determination

Approximately 150 mg of sample was placed into a PTFE NMR tube and dissolved with 2 mL of a 0.1 mM Cr(OAcAc)₃ in CDCl₃. Si²⁹ NMR data was collected on a 600 MHz JEOL NMR spectrometer with a 10 mm JEOL silicon free probe. M:Q ratios were determined by integrating the M region of the Si²⁹ NMR spectrum, between 17 and 5 ppm. The Q region in the Si²⁹ NMR spectrum, between −90 and −115 ppm, was also integrated. M:Q ratio is the corresponding integral ratio. The data are shown in Table 4, below.

### Poly(Alkyleneoxide)-Modified Polydimethylsiloxane Molecular Weight Determination

Approximately 150 mg of resin was placed into a PTFE NMR tube and dissolved with 2 mL of a 0.1 mM Cr(OAcAc)₃ in CDCl₃. Si²⁹ NMR data was collected on a 600 MHz JEOL NMR spectrometer with a 10 mm JEOL silicon free probe to determine number average molecular weight. The data are shown in Table 4, below.

### Preparation of Surface-Modified Nanoparticles

A 1-liter 3-neck round bottom flask was charged with 350 g of aqueous colloidal silica dispersion “NALCO 2326”, and stirring was started. Then 222 g of 2-propanol was added slowly. A small exotherm was observed. After approximately 10 minutes of mixing time, 25.6 g of n-octyltrimethoxy silane was added followed by 2.6 g of methyltrimethoxysilane and a rinse of 19 g of 2-propanol. The mixture was heated to 82° C. The mixture became a thick white slurry at about 80° C. The mixture was held at 82° C. for 4 hours then cooled to 25° C. The mixture was transferred to a 1-neck pear shaped flask, rinsing with about 120 g of 2-propanol. Solvent was removed by rotary evaporation (bath temperature 50° C., vacuum slowly lowered to 80 mmHg). About 370 g of distillate was removed, and the mixture was cooled to 25° C. To the mixture was added 80.0 g of 2-EHA and 0.02 g of phenothiazine. This mixture was subjected to rotary evaporation (bath temperature initially 35° C. and increased to 50° C., vacuum slowly lowered to 19 mmHg) to remove any remaining solvent and water. The material transitions from hazy to clear when the water is removed. The resulting 149.1 g of product, which is 50 wt % surface-modified nanoparticles in 2-EHA, was transferred from the flask to a jar.

### Examples 1 to 10 (EX 1 to EX 10) and Comparative Examples (CE 1 to CE 4) for Foam Column Screen Test

In a tall glass sample vial, 0.20 g of a 70:30 mixture of surface-modified nanoparticles (50 wt % in 2-EHA) and a silicone MQ resin or a poly(alkyleneoxide)-modified polydimethylsiloxane (as shown in Table 4, below) was measured and added for EX 1 to EX10. For CE 1, only 0.20 g of surface-modified nanoparticles (50 wt % in 2-EHA) was added. For CE 2 to CE 4, only 0.20 g of the poly(alkyleneoxide)-modified polydimethylsiloxane indicated in Table 4, below, was added. For Examples 3 and 4, 0.1 g of 2-EHA was added. For Examples 7 to 9, 0.06 g of 2-EHA was added since without the addition of 2-EHA, the sample gelled. 10.0 g of acrylic monomer mixture (90 parts by weight 2-EHA: 10 parts by weight AA) was then added to sample vial. The sample vial was capped and evaluated using the Foam Column Screening Test describe below. The data are shown in Table 4, below.

### Foam Column Screening Test (Manually Agitated)

The prepared samples of acrylic monomer mixtures containing Examples 1 to 10 and Comparative Examples CE 1 to CE 4 were fully combined by shaking the sample vial vigorously for 15 seconds and allowing contents to settle. The sample vial was then placed on a level surface. Foam height was measured visually using a ruler. Photos were taken, and data was recorded immediately to document foamed column height. The time necessary for half of the liquid to be drained from the foam (i.e., to provide half of the initial volume of liquid) was measured and is reported as the foam half-life. The overall assessment is further described in Table 2, below.

TABLE 2
Overall Assessment of Foam Height and Foam Persistence

| Rating | 0 | 1 | 2 | 3 | 4 | 5 |
|---|---|---|---|---|---|---|
| Description | Heterogeneous | ~1 layer | Slightly | Moderate | Substantial | High |
| | and/or no foam | of bubbles | more | foam, not | foam, | foam, |
| | | | bubbles | persistent | persistent | persistent |
| Height (cm) | 23-25 | 26-28 | 29-32 | 33-36 | 37-40 | 41+ |
| (liquid + | | | | | | |
| foam) | | | | | | |
| Height foam | 0-2 | 3-5 | 6-9 | 10-13 | 14-17 | 18+ |
| only (cm) | | | | | | |
| Foam Half- | <1 | <1 | <2 | <4 | 5 to 14 | 15+ |
| Life (min) | | | | | | |

### Examples 1A to 10A (EX 1A to EX 10A) and Comparative Examples (CE 1A to CE 4A) for Syrup Bubbing Test

Coatable viscosity syrup polymers were prepared by charging a one-quart jar with 90 parts of 2-EHA and 10 parts of AA and “OMNIRAD 651” (0.04 parts per hundred parts of monomers), and stirred until the photoinitiator had dissolved and a homogeneous mixture was obtained. The mixture was degassed by introducing nitrogen gas into it through a tube inserted through an opening in the jar's cap and bubbling vigorously for at least 5 minutes. While stirring, the mixture was exposed to UV-A light until a pre-adhesive syrup having a viscosity deemed suitable for coating was formed. Following UV exposure, air was introduced into the jar. The light source was an array of LEDs having a peak emission wavelength of 365 nm.

In a 4 oz. glass jar equipped with a magnetic stir bar, 30.0 g of the syrup was measured. 0.30 g a 70:30 mixture of surface-modified nanoparticles (50 wt % in 2-EHA) and a silicone MQ resin or a poly(alkyleneoxide)-modified polydimethylsiloxane (as shown in Table 4, below) was then added to the glass jar for EX 1A to EX10A. For CE 1A, only 0.30 g of surface-modified nanoparticles (50 wt % in 2-EHA) was added. For CE 2A to CE 4A, only 0.30 g of the poly(alkyleneoxide)-modified polydimethylsiloxane indicated in Table 4, below was added. For Examples 3 and 4, 0.15 g of 2-EHA was added. For Examples 7 to 9, 0.09 g of 2-EHA was added. The sample was then capped. The sample was stirred on a magnetic stir plate for five minutes and then subjected to the Syrup Bubbling Test described below. The data are shown in Table 4, below.

### Syrup Bubbling Test

The bubbling apparatus was set up. A house nitrogen line was connected to a Cole-Palmer 5 LPM flow meter. The flow meter was connected to tubing equipped with a long 18 Ga needle. The prepared sample glass jar lid was replaced with a glass adaptor-equipped lid, in which the glass adapter is a hollow tube affixed through a hole in the standard jar lid. A septum was inserted into the glass adaptor along with a 16 Ga needle (for venting). The long 18 Ga needle was then inserted into the septum. The nitrogen was then turned on and the flow was adjusted to 4 LPM and the venting needle was verified to be functional. The magnetic stir bar was then stirred with the “low” setting on a magnetic stir plate. The long needle was then pushed to the bottom of the jar. The apparatus was let to bubble for five minutes. The needle was then removed, and the magnetic stir bar was turned off. The closed glass jar lid was then reapplied, and the glass jar was allowed to sit at surface level.

Foam height was measured visually using a ruler. Photos were taken, and data was recorded immediately to document foamed column height and persistence. The time necessary for half of the liquid to be drained from the foam (i.e., to provide half of the initial volume of liquid) was measured and is reported as the foam half-life. The overall assessment is shown in Table 3, below.

TABLE 3
Foam Height and Foam Persistence for Syrup Bubbling Test

| Rating | 0 | 1 | 2 | 3 | 4 | 5 |
|---|---|---|---|---|---|---|
| Description | Heterogeneous | Scattered | Slightly | Moderate | Substantial | High |
| | and/or no foam | bubbles | more | foam, | foam, | foam, |
| | | throughout | bubbles | quickly | slowly | persistent |
| | | bulk | throughout | phase | phase | |
| | | | bulk | separates | separates | |
| Height (cm) | <35 | 35-40 | 41-45 | 45-60 | 45-60 | 53-75 |
| (liquid + | | | | | | |
| foam) | | | | | | |
| Foam Half- | n.a. | n.a. | n.a. | <15 | 15-59 | 60+ |
| life (min) | | | | | | |

n.a. = not applicable because so little foam was produced

TABLE 4
Examples EX 1-EX 10 and EX1A-EX-10A and Comparative Examples
CE 1-CE 4 and CE 1Ato CE 4A Compositions and Results

| | | | | Syrup |
|---|---|---|---|---|
| | | M:Q Ratio | Manually | Bub- |
| | Additive and/or | or polysi- | Agitated | bling |
| Example | Blend | loxane mw | Rating | Rating |
| EX 1, EX 1A | SMN^{a} + | 1.7:1.0 | 5 | 5 |
| | SILMER Q25 | | | |
| EX 2, EX 2A | SMN + SILMER | 1.7:1.0 | 5 | 5 |
| | Q25 | | | |
| EX 3, EX 3A | SMN + SILMER | 1.6:1.0 | 5 | 5 |
| | Q20 + EHA | | | |
| EX 4, EX 4A | SMN + SILMER | 1.6:1.0 | 4 | 4 |
| | Q20 + EHA | | | |
| EX 5, EX 5A | SMN + SQO-299 | 0.9:1.0 | 4 | 4 |
| EX 6, EX 6A | SMN + SQO-299 | 0.9:1.0 | 4 | 4 |
| EX 7, EX 7A | SMN + 2-EHA + | 3600 g/mol | 5 | 5 |
| | EFKA SL 3299 | | | |
| EX 8, EX 8A | SMN + 2-EHA + | 3600 g/mol | 5 | 5 |
| | EFKA SL 3299 | | | |
| EX 9, EX 9A | SMN + 2-EHA + | 36000 g/mol | 3 | 3 |
| | EFKA SL 3030 | | | |
| EX 10, EX | SMN + SILWET | n.d.^{b} | 4 | 4 |
| 10A | L77 | | | |
| CE 1, CE 1A | SMN | n.a.^{c} | 4 | 4 |
| CE 2, CE 2A | EFKA SL 3299 | 3600 g/mol | 4 | 4 |
| CE 3, CE 3A | EFKA SL 3030 | 36000 g/mol | 3 | 3 |
| CE 4, CE 4A | SILWET L77 | n.d. | 3 | 3 |

^{a}SMN = surface-modified nanoparticles
^{b}n.d. = not determined
^{c}n.a. = not applicable

Various modifications and alterations of this disclosure may be made by those skilled the art without departing from the scope and spirit of the disclosure, and it should be understood that this invention is not to be unduly limited to the illustrative embodiments set forth herein.

1. A foam composition comprising:
a vehicle having voids therein;
surface-modified nanoparticles having a particle diameter of not more than 100 nanometers; and
at least one of a silicone MQ resin or a poly(alkyleneoxide)-modified polydimethylsiloxane.

2. The foam composition of claim 1, wherein the foam composition comprises the silicone MQ resin.

3. The foam composition of claim 2, wherein the silicone MQ resin has an M:Q ratio of at least 0.8:1.

4. The foam composition of claim 2, wherein the MQ resin comprises methyl groups and has a hydroxyl content in a range from 185 to 1840 milliequivalents per kilogram.

5. The foam composition of claim 1, wherein the foam composition comprises the poly(alkyleneoxide)-modified polydimethylsiloxane, which has a number average molecular weight of not more than 50,000 grams per mole, and wherein the alkylene oxide comprises ethyleneoxy groups, propyleneoxy groups, or a combination thereof.

6. The foam composition of claim 1, wherein the silicone MQ resin, the poly(alkyleneoxide)-modified polydimethylsiloxane, or a combination thereof is present in the foam composition at a level from 0.1 to 10 weight percent based on the total weight of the foam composition.

7. The foam composition of claim 1, wherein the vehicle comprises at least one of a polymer or a monomer.

8. The foam composition of claim 1, wherein the vehicle is not a silicone or silicone-containing polymer.

9. The foam composition of claim 1, wherein the vehicle comprises at least one of a polyester, a polyurethane, a polyurea, an amino resin, an alkyd resin, a phenolic resin, an epoxy resin, an isocyanate resin, an isocyanurate resin, or an acrylic polymer.

10. The foam composition of claim 1, wherein the surface-modified nanoparticles comprise at least one of silica, titania, alumina, zirconia, vanadia, ceria, iron oxide, antimony oxide, tin oxide, or aluminum/silica.

11. The foam composition of claim 1, wherein the surface-modified nanoparticles comprise surface groups derived from a silane, organic acid, organic base, or a combination thereof.

12. The foam composition of claim 1, wherein the surface-modified nanoparticles are present in the foam composition in a range from 0.1 to 10 weight percent based on the total weight of the foam composition.

13. The foam composition of claim 1, wherein the vehicle comprises an adhesive composition.

14. An adhesive tape comprising the foam composition of claim 13.

15. A process for making the foam composition of claim 1, the process comprising introducing a foaming agent into a composition comprising the vehicle, the surface-modified nanoparticles having a particle diameter of not more than 100 nanometers, and at least one of the silicone MQ resin or the poly(alkyleneoxide)-modified polydimethylsiloxane to form voids in the composition.
